(19) United States
(12) Patent Application Publication
(10) Pub. No.: US 2024/0256894 A1
(43) Pub. Date: Aug. 1, 2024

(54) REPROGRAMMABLE FEDERATED LEARNING

(71) Applicants: International Business Machines Corporation, Armonk, NY (US); Rensselaer Polytechnic Institute, Troy, NY (US)

(72) Inventors: Pin-Yu Chen, White Plains, NY (US); Bo Wu, Cambridge, MA (US); Zhenfang Chen, Cambridge, MA (US); Chuang Gan, Cambridge, MA (US); Huzaifa Arif, Troy, NY (US)

(21) Appl. No.: 18/162,894

(22) Filed: Feb. 1, 2023

(51) Int. Cl. G06N 3/098

(52) U.S. Cl. CPC G06N 3/098

(57) ABSTRACT

Systems and techniques that facilitate reprogrammable federated learning are provided. In various embodiments, a server device can share a pre-trained and frozen neural network with a set of client devices. In various aspects, the server device can orchestrate reprogrammable federated learning of the pre-trained and frozen neural network among the set of client devices. In various instances, the pre-trained and frozen neural network can be positioned between at least one trainable input layer and at least one trainable output layer, and the reprogrammable federated learning can involve the at least one trainable input layer and the at least one trainable output layer, but not the pre-trained and frozen neural network, being locally adjusted by the set of client devices.

### BACKGROUND

The subject disclosure relates to federated learning, and more specifically to reprogrammable federated learning.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate reprogrammable federated learning are described.

According to various embodiments, a system can be provided. In various aspects, the system can comprise at least one processor that can execute computer-executable components stored in at least one non-transitory computer-readable memory. In various instances, the computer-executable components can comprise a model component that can share a pre-trained and frozen neural network with a set of client devices. In various cases, the computer-executable components can comprise a training component that can orchestrate reprogrammable federated learning of the pre-trained and frozen neural network among the set of client devices. In various aspects, the pre-trained and frozen neural network can be positioned between at least one trainable input layer and at least one trainable output layer, and the reprogrammable federated learning can involve the at least one trainable input layer and the at least one trainable output layer, but not the pre-trained and frozen neural network, being locally adjusted by the set of client devices.

According to various embodiments, the above-described system can be implemented as a computer-implemented method or as a computer program product.

### DESCRIPTION OF THE DRAWINGS

FIG. 1 illustrates a block diagram of an example, non-limiting system that facilitates reprogrammable federated learning in accordance with one or more embodiments described herein.

FIG. 2 illustrates an example, non-limiting block diagram showing a local training dataset in accordance with one or more embodiments described herein.

FIG. 3 illustrates a block diagram of an example, non-limiting system including a pre-trained, frozen neural network that facilitates reprogrammable federated learning in accordance with one or more embodiments described herein.

FIG. 4 illustrates a block diagram of an example, non-limiting system including at least one trainable input layer and at least one trainable output layer that facilitates reprogrammable federated learning in accordance with one or more embodiments described herein.

FIG. 5 illustrates a block diagram of an example, non-limiting system in which a pre-trained, frozen neural network sandwiched between at least one trainable input layer and at least one trainable output layer has been shared among a set of clients in accordance with one or more embodiments described herein.

FIG. 6 illustrates a block diagram of an example, non-limiting system including a current global internal parameter value array that facilitates reprogrammable federated learning in accordance with one or more embodiments described herein.

FIG. 7 illustrates a block diagram of an example, non-limiting system including a set of locally-updated internal parameter value arrays that facilitates reprogrammable federated learning in accordance with one or more embodiments described herein.

FIGS. 8-9 illustrate example, non-limiting block diagrams showing how a set of locally-updated internal parameter value arrays can be obtained in accordance with one or more embodiments described herein.

FIG. 10 illustrates a block diagram of an example, non-limiting system including a new global internal parameter value array that facilitates reprogrammable federated learning in accordance with one or more embodiments described herein.

FIG. 11 illustrates an example, non-limiting block diagram showing how a new global internal parameter value array can be obtained from a set of locally-updated internal parameter value arrays in accordance with one or more embodiments described herein.

FIG. 12 illustrates an example, non-limiting communication diagram associated with reprogrammable federated learning in accordance with one or more embodiments described herein.

FIG. 13 illustrates a flow diagram of an example, non-limiting computer-implemented method that facilitates reprogrammable federated learning in accordance with one or more embodiments described herein.

FIG. 14 illustrates example, non-limiting algorithms that facilitate reprogrammable federated learning in accordance with one or more embodiments described herein.

FIGS. 15-17 illustrate example, non-limiting experimental results associated with reprogrammable federated learning in accordance with one or more embodiments described herein.

FIG. 18 illustrates a flow diagram of an example, non-limiting computer-implemented method that facilitates reprogrammable federated learning in accordance with one or more embodiments described herein.

FIG. 19 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Federated learning can involve iteratively training a deep learning neural network on training data that is distributed across a plurality of clients. During an iteration of federated learning, each client can train (e.g., via stochastic gradient descent (SGD)) its own local instance of a current version of the deep learning neural network, and such plurality of locally-trained instances can be aggregated together to create a globally-updated version of the deep learning neural network. Such globally-updated version of the deep learning neural network can be treated as the current version of the deep learning neural network during a next iteration of federated learning. Such iterations can repeat until any suitable training termination criterion is achieved, at which point the most recent globally-updated version of the deep learning neural network can be considered as being the complete, finished, or fully trained version of the deep learning neural network.

During federated learning, it can be desirable to protect the privacy of the local training data of each client. In other words, it can be desirable to prevent or otherwise impede the training data of one client from being shared with, accessible to, or otherwise inferred by another client. After all, such local training data can, in some instances, be subject to ethical or legal disclosure restrictions. For example, in the clinical context, such local training data can include medical scanned images or other medical records of specific medical patients, and the privacy of such scanned images or records can be highly regulated.

It was previously believed that federated learning by itself provides sufficient protection for client privacy. After all, during federated learning, the clients can communicate their locally-updated instances of the deep learning neural network (e.g., the internal parameters or gradients of their locally-updated instances) rather than their private training data. However, such communication can nevertheless be vulnerable to data leakage risks, such as membership inference attacks or gradient leakage attacks.

Differential privacy techniques can help to protect against such data leakage risks during federated learning. In particular, differentially private stochastic gradient descent (DP-SGD) can be considered as a modification of SGD that incorporates noise to reduce privacy loss. Accordingly, privacy can be better preserved during federated learning when each client utilizes DP-SGD to update its own local instance of the deep learning neural network, as compared to when each client instead utilizes SGD to update its own local instance of the deep learning neural network. However, when DP-SGD is implemented in federated learning, each locally-trained instance of the deep learning neural network can be more likely to suffer from degraded accuracy, and thus the globally-updated version of the deep learning neural network can likewise be more likely to suffer from degraded accuracy. Thus, differentially private federated learning can be considered as involving a trade-off between training data privacy and neural network accuracy.

According to some existing techniques, differentially private federated learning can be performed by having each client train, via DP-SGD, its own local instance of the deep learning neural network from scratch. In other words, each client can update the trainable internal parameters of its local instance of the deep learning neural network during each iteration of federated learning, and such trainable internal parameters can begin in the first iteration with randomly initialized values. Unfortunately, such existing techniques often cannot achieve both acceptable neural network accuracy and acceptable training data privacy. After all, if the deep learning neural network begins from scratch, achieving acceptably high neural network accuracy can depend upon performing very many global-updates to the deep learning neural network. However, the more global-updates that are performed, the less secure or protected each client's training data can be. Thus, such existing techniques can be considered as disadvantageous.

According to other existing techniques, the deep learning neural network can be pre-trained in a non-federated manner, and differentially private federated learning can be subsequently performed by having each client fully fine-tune, via DP-SGD, its own local instance of the pre-trained deep learning neural network. In other words, each client can update all of the trainable internal parameters of its local instance of the deep learning neural network during each iteration of federated learning, and such trainable internal parameters can begin in the first iteration with pre-trained values rather than with randomly initialized values. Because the deep learning neural network can be pre-trained, such full fine-tuning can involve fewer global-updates than can training from scratch, which can be considered as fewer opportunities for the clients' private training data to be leaked or attacked. Thus, full fine-tuning can achieve a better privacy-accuracy tradeoff as compared to training from scratch.

According to yet other existing techniques, the deep learning neural network can be pre-trained in a non-federated manner, and differentially private federated learning can be subsequently performed by having each client partially fine-tune, via DP-SGD, its own local instance of the pre-trained deep learning neural network. In other words, each client can update fewer than all of the trainable internal parameters of its local instance of the deep learning neural network during each iteration of federated learning, and such trainable internal parameters can begin in the first iteration with pre-trained values rather than with randomly initialized values. Because the deep learning neural network can be pre-trained, such partial fine-tuning can involve fewer global-updates than can training from scratch. Moreover, because such partial fine-tuning can involve updating fewer than all of the trainable internal parameters of the pre-trained deep learning neural network, such partial fine-tuning can involve fewer global-updates than can full fine-tuning. So, partial fine-tuning can achieve a better privacy-accuracy tradeoff as compared to training from scratch and as compared to full fine-tuning.

In any case, systems or techniques that can even further improve upon the privacy-accuracy tradeoff of differentially private federated learning can be considered as desirable.

Various embodiments described herein can address one or more of these technical problems. One or more embodiments described herein can include systems, computer-implemented methods, apparatus, or computer program products that can facilitate reprogrammable federated learning. More specifically, the inventors of various embodiments described herein realized that the privacy-accuracy tradeoff of differentially private federated learning can be improved as compared to training from scratch, as compared to full fine-tuning, and even as compared to partial fine-tuning, by leveraging model reprogramming.

Model reprogramming can be considered as a technique for facilitating resource-efficient cross-domain machine learning as an alternative to fine-tuning. Moreover specifically, and as mentioned above, fine-tuning (whether full or partial) can involve training a deep learning neural network to handle new training data, by altering at least some trainable internal parameters (e.g., weight matrices, bias values, convolutional kernels) of the deep learning neural network, where such at least some trainable internal parameters have already been trained. In stark contrast to fine-tuning, model reprogramming can involve configuring the deep learning neural network to handle new training data, by freezing the trainable internal parameters of the deep learning neural network that have already been trained and by sandwiching the deep learning neural network between at least one randomly-initialized trainable input layer and at least one randomly-initialized trainable output layer. Accordingly, during model reprogramming, the trainable internal parameters of those newly added layers can be trained, whereas the trainable internal parameters of the deep learning neural network can be preserved or unaltered. In various aspects, model reprogramming can be considered as a more efficient technique for training the deep learning neural network to handle the new training data. Indeed, since at least some pre-trained internal parameters of the deep learning neural network can be altered during fine-tuning, fine-tuning can be considered as undoing or otherwise tampering with the inferencing capabilities that were learned by the deep learning neural network during its pre-training. In stark contrast, since the pre-trained internal parameters of the deep learning neural network can remain unchanged during model reprogramming, model reprogramming can be considered as not undoing or otherwise tampering with the inferencing capabilities that were learned by the deep learning neural network during its pre-training.

Accordingly, the present inventors realized that federated learning in general, and differentially private federated learning in particular, can be improved via implementation of model reprogramming. In other words, rather than training a deep learning neural network from scratch in a federated fashion, and rather than performing full or partial fine-tuning on the deep learning neural network in a federated fashion, the present inventors devised various embodiments described herein in which model reprogramming can be performed on the deep learning neural network in a federated fashion. Such a technique can be referred to as reprogrammable federated learning. As explained herein, various experiments conducted by the present inventors verify that reprogrammable federated learning can outperform federated training from scratch, federated full fine-tuning, and federated partial fine-tuning.

Various embodiments described herein can be considered as a computerized tool (e.g., any suitable combination of computer-executable hardware or computer-executable software) that can facilitate reprogrammable federated learning. In various aspects, such computerized tool can comprise a model component and a training component.

In various embodiments, there can be a set of client devices. In various aspects, the set of client devices can collectively store or otherwise maintain a set of local training datasets. In other words, each client device can privately store or maintain a respective local training dataset. In various instances, each local training dataset can include a plurality of local training data candidates and a respectively corresponding plurality of local ground-truth annotations. In various instances, a local training data candidate can be any suitable electronic data having any suitable format, size, or dimensionality (e.g., a local training data candidate can be any suitable number of scalars, vectors, matrices, tensors, or character strings). In various cases, a local ground-truth annotation can be any suitable electronic data having any suitable format, size, or dimensionality that can be known or deemed to be the result that would be obtained if a given inferencing task (e.g., segmentation, classification, regression) were correctly or accurately performed on a respective local training data candidate.

In various embodiments, the model component of the computerized tool can electronically store, maintain, control, or otherwise access a pre-trained deep learning neural network. In various aspects, the pre-trained deep learning neural network can exhibit any suitable internal architecture. For example, the pre-trained deep learning neural network can include any suitable numbers of any suitable types of layers (e.g., initial layer, one or more hidden layers, final layer, any of which can be convolutional layers, dense layers, non-linearity layers, pooling layers, batch normalization layers, or padding layers). As another example, the pre-trained deep learning neural network can include any suitable numbers of neurons in various layers (e.g., different layers can have the same or different numbers of neurons as each other). As yet another example, the pre-trained deep learning neural network can include any suitable activation functions (e.g., softmax, sigmoid, hyperbolic tangent, rectified linear unit) in various neurons (e.g., different neurons can have the same or different activation functions as each other). As still another example, the pre-trained deep learning neural network can include any suitable interneuron connections or interlayer connections (e.g., forward connections, skip connections, recurrent connections).

Regardless of its internal architecture, the pre-trained deep learning neural network can have been already trained (e.g., via supervised training, unsupervised training, or reinforcement learning) to perform any suitable inferencing task. In some instances, the pre-trained deep learning neural network can have been already trained to perform the given inferencing task mentioned above. However, in other instances, the pre-trained deep learning neural network can instead have been already trained to perform a different inferencing task. In either case, it can be desired to perform reprogrammable federated learning of the pre-trained deep learning neural network using the set of local training datasets respectively stored by the set of client devices. As described herein, the computerized tool can facilitate such reprogrammable federated learning.

In various embodiments, the model component can electronically outfit or equip the pre-trained deep learning neural network with a trainable input layer and a trainable output layer. More specifically, the model component can install or otherwise insert the trainable input layer at or before an upstream end of the pre-trained deep learning neural network. Similarly, the model component can install or otherwise insert the trainable output layer at or after a downstream end of the pre-trained deep learning neural network. Accordingly, the pre-trained deep learning neural network can be considered as being sandwiched or otherwise positioned in between the trainable input layer and the trainable output layer.

In various aspects, the model component can electronically share the pre-trained deep learning neural network, as equipped with the trainable input layer and the trainable output layer, with the set of client devices. Accordingly, each client device can be considered as having its own local instance or copy of the trainable input layer, of the pre-trained deep learning neural network, and of the trainable output layer.

In various aspects, the training component of the computerized tool can electronically orchestrate reprogrammable federated learning of the trainable input layer, of the pre-trained deep learning neural network, and of the trainable output layer among the set of client devices.

In particular, during any current iteration of reprogrammable federated learning, the training component can electronically generate a current global internal parameter value array. In various instances, the current global internal parameter value array can be any suitable array (e.g., can be any suitable combination of scalars, vectors, matrices, or tensors) that can indicate numerical values that can be taken by or otherwise assigned to the trainable internal parameters of the trainable input layer and of the trainable output layer.

If the current iteration of reprogrammable federated learning is the first or initial iteration, then the training component can generate the current global internal parameter value array via random initialization. Otherwise, the current global internal parameter value array can be equal to (or otherwise based on) whatever new global internal parameter value array was produced during an immediately previous iteration of reprogrammable federated learning.

In various aspects, during the current iteration, the training component can electronically transmit the global internal parameter value array to each of the set of client devices. In various instances, such transmission can be considered as an instruction for each client device to locally train its own local instance of the trainable input layer and of the trainable output layer using the current global internal parameter value array as a parameter initialization. In various cases, the set of client devices can perform such local training in response to receiving the current global internal parameter value array, and this can cause the set of client devices to respectively generate (e.g., via iteratively performing DP-SGD) a set of locally-updated internal parameter value arrays.

In various aspects, the training component can, during the current iteration of reprogrammable federated learning, electronically generate a new global internal parameter value array, based on the set of locally-updated internal parameter value arrays. In particular, the training component can aggregate (e.g., via averaging, weighted averaging, federated averaging) the set of locally-updated internal parameter value arrays together, and such aggregation can be considered as the new global internal parameter value array.

In various aspects, the training component can facilitate in this fashion any suitable number of iterations of reprogrammable federated learning. Once such reprogrammable federated learning is completed (e.g., once any suitable training termination criterion is achieved), the most-recently-created new global internal parameter value array can be considered as representing the fully trained parameter values of the trainable input layer and of the trainable output layer. As the present inventors have experimentally verified, performing reprogrammable federated learning as described herein can provide a better or improved privacy-accuracy tradeoff (e.g., can provide more neural network accuracy for a given privacy budget), as compared to federated learning techniques that rely upon training from scratch or fine-tuning (whether full or partial).

Various embodiments described herein can be employed to use hardware or software to solve problems that are highly technical in nature (e.g., to facilitate reprogrammable federated learning), that are not abstract and that cannot be performed as a set of mental acts by a human. Further, some of the processes performed can be performed by a specialized computer (e.g., deep learning neural network layers) for carrying out defined acts related to reprogrammable federated learning. For example, such defined acts can include: sharing, by a server device operatively coupled to a processor, a pre-trained and frozen neural network with a set of client devices; and orchestrating, by the server device, reprogrammable federated learning of the pre-trained and frozen neural network among the set of client devices. In various instances, the pre-trained and frozen neural network can be positioned between at least one trainable input layer and at least one trainable output layer, and the reprogrammable federated learning can involve the at least one trainable input layer and the at least one trainable output layer, but not the pre-trained and frozen neural network, being locally adjusted by the set of client devices.

Such defined acts are not performed manually by humans. Indeed, neither the human mind nor a human with pen and paper can: electronically equip a pre-trained deep learning neural network with a trainable input layer and a trainable output layer; electronically distribute the trainable input layer, the pre-trained deep learning neural network, and the trainable output layer among a set of client devices (e.g., client computers); and electronically instruct such set of client devices to locally train the trainable input layer and the trainable output layer but not the pre-trained deep learning neural network. Indeed, deep learning neural networks are inherently computerized constructs that cannot be executed or trained by the human mind, even with the assistance of pen and paper. Accordingly, a computerized tool that can insert new layers into a deep learning neural network and that can train such new layers in federated fashion is inherently-computerized and cannot be implemented in any sensible, practical, or reasonable way without computers.

Moreover, various embodiments described herein can integrate into a practical application various teachings relating to reprogrammable federated learning. As explained above, existing techniques for performing federated learning (e.g., differentially private federated learning, in particular) implement training from scratch or fine-tuning. Training from scratch cannot achieve sufficiently high neural network accuracy without performing very many global updates. However, such very many global updates expose federated clients' private training data to progressively higher risk. Accordingly, training from scratch can be considered as providing a poor privacy-accuracy tradeoff. In contrast, fine-tuning (full or partial) can allow a higher level of neural network accuracy to be achieved with fewer global updates. Accordingly, fine-tuning can be considered as providing a better privacy-accuracy tradeoff as compared to training from scratch. However, the improved privacy-accuracy tradeoff of fine-tuning can sometimes be considered as not sufficient. Accordingly, systems or techniques that can provide an even better privacy-accuracy tradeoff as compared to fine-tuning can thus be considered as desirable.

Various embodiments described herein can address one or more of these technical problems, by facilitating reprogrammable federated learning. In particular, fine-tuning can involve altering at least some internal parameters of a neural network, which internal parameters have already undergone training. In contrast, model reprogramming can be considered as not altering such already-trained internal parameters. Instead, model reprogramming can involve sandwiching a pre-trained neural network in series between a newly-inserted trainable input layer and a newly-inserted trainable output layer. Because model reprogramming can avoid altering the pre-trained neural network (e.g., the pre-trained neural network can be frozen), model reprogramming can be considered as not wasting, undoing, or redoing any previous learning that was accomplished by the pre-trained neural network. In stark contrast, because fine-tuning can involve altering the pre-trained neural network (e.g., the pre-trained neural network can be not frozen), fine-tuning can be considered as wasting, undoing, or redoing at least some previous learning that was accomplished by the pre-trained neural network. Accordingly, model reprogramming can be considered as a more effective or efficient technique for facilitating federated learning as compared to fine-tuning. Indeed, the present inventors experimentally verified that reprogrammable federated learning outperforms (e.g., achieves a better privacy-accuracy tradeoff than) fine-tuning-based federating learning (both full and partial). Accordingly, various embodiments described herein certainly constitute concrete and tangible technical improvements in the field of federated learning, and thus such embodiments clearly qualify as useful and practical applications of computers.

Furthermore, various embodiments described herein can control real-world tangible devices based on the disclosed teachings. For example, various embodiments described herein can electronically train or execute real-world neural networks.

It should be appreciated that the herein figures and description provide non-limiting examples of various embodiments and are not necessarily drawn to scale.

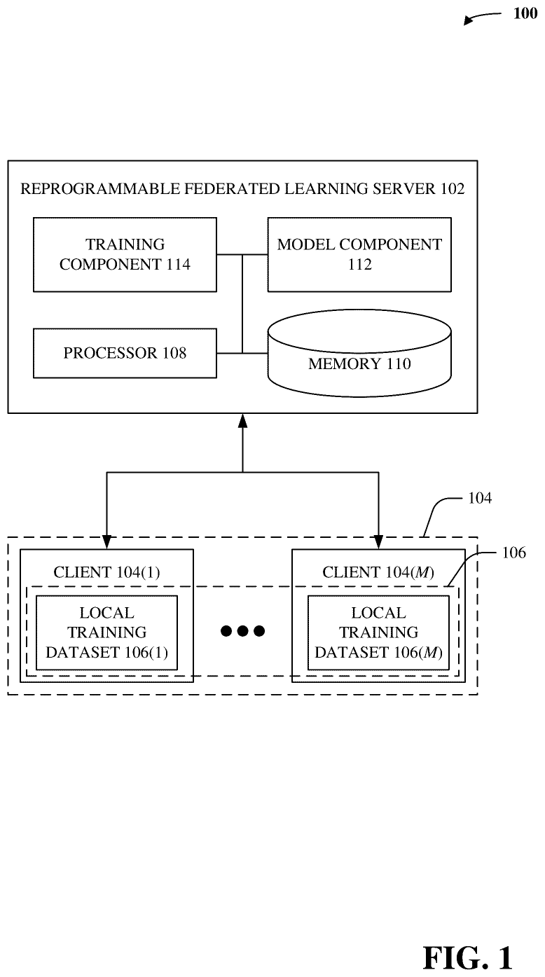

FIG. 1 illustrates a block diagram of an example, non-limiting system 100 that can facilitate reprogrammable federated learning in accordance with one or more embodiments described herein. As shown, a reprogrammable federated learning server 102 (hereafter “RFL server 102”) can be electronically integrated, via any suitable wired or wireless electronic connections, with a set of clients 104.

In various embodiments, the set of clients 104 can comprise m clients, for any suitable positive integer m: a client 104(1) to a client 104(m). In some aspects, m can be equal to 1. However, in other aspects, m can be greater than or equal to 2. In various instances, each of the set of clients 104 can be any suitable computing device. As a non-limiting example, any of the set of clients 104 can be a laptop computer. As another non-limiting example, any of the set of clients 104 can be a desktop computer. As yet another non-limiting example, any of the set of clients 104 can be a smart phone. As even another non-limiting example, any of the set of clients 104 can be a vehicle-integrated computer (e.g., a computer built into an automobile, into an aircraft, or into a watercraft). Although not explicitly shown in FIG. 1 for sake of space, each of the set of clients 104 can be considered as comprising a respective computer processor and a respective non-transitory computer-readable memory.

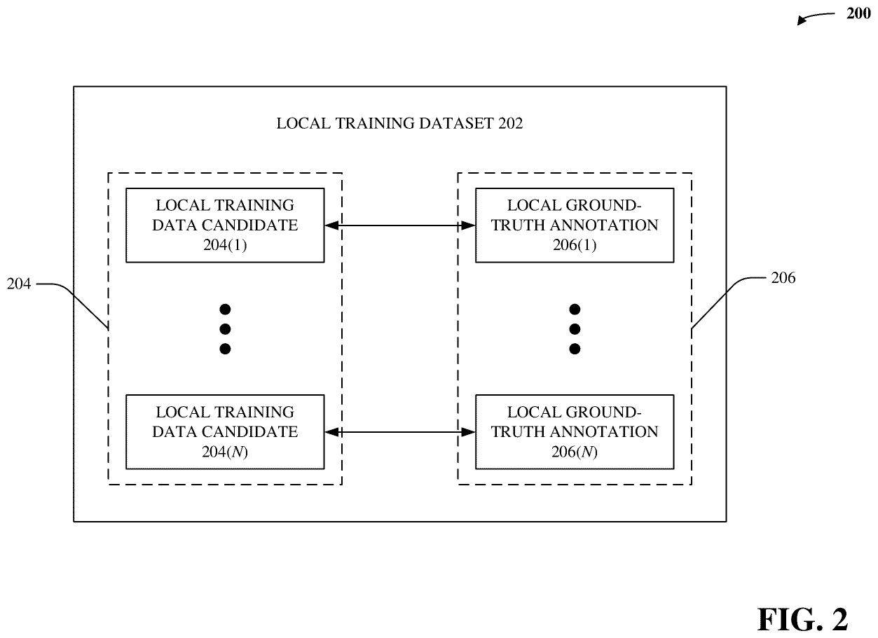

In any case, the set of clients 104 can electronically store, electronically maintain, electronically control, or otherwise electronically access a set of local training datasets 106. In various aspects, the set of local training datasets 106 can respectively correspond (e.g., in one-to-one fashion) to the set of clients 104. Accordingly, since the set of clients 104 can comprise m clients, the set of local training datasets 106 can comprise m datasets: a local training dataset 106(1) to a local training dataset 106(m). In various instances, each of the set of clients 104 can store, maintain, control, or otherwise access a respective one of the set of local training datasets 106. As a non-limiting example, the client 104(1) can store, maintain, control, or otherwise access the local training dataset 106(1). Likewise, the client 104(m) can store, maintain, control, or otherwise access the local training dataset 106(m). In any case, each of the set of local training datasets 106 can comprise a respective set of local training data candidates and a respective set of local ground-truth annotations, as described with respect to FIG. 2.

FIG. 2 illustrates an example, non-limiting block diagram 200 showing a local training dataset in accordance with one or more embodiments described herein.

In various aspects, there can be a local training dataset 202. In various instances, the local training dataset 202 can be any one of the set of local training datasets 106. Accordingly, the local training dataset 202 can be stored, maintained, controlled, or otherwise accessed by a respective one of the set of clients 104.

As shown, the local training dataset 202 can comprise a set of local training data candidates 204 and a set of local ground-truth annotations 206. In various aspects, the set of local training data candidates 204 can comprise n data candidates for any suitable positive integer n: a local training data candidate 204(1) to a local training data candidate 204(n). In various instances, each of the set of local training data candidates 204 can be any suitable electronic data exhibiting any suitable format, size, or dimensionality. In other words, each of the set of local training data candidates 204 can be one or more scalars, one or more vectors, one or more matrices, one or more tensors, one or more character strings, or any suitable combination thereof. As a non-limiting example, each of the set of local training data candidates 204 can be a two-dimensional pixel array. As another non-limiting example, each of the set of local training data candidates 204 can be a three-dimensional voxel array. As yet another non-limiting example, each of the set of local training data candidates 204 can be a timeseries. As even another non-limiting example, each of the set of local training data candidates 204 can be a text string.

In various aspects, the set of local ground-truth annotations 206 can respectively correspond (e.g., in one-to-one fashion) with the set of local training data candidates 204. Accordingly, since the set of local training data candidates 204 can comprise n data candidates, the set of local ground-truth annotations 206 can comprise n annotations: a local ground-truth annotation 206(1) to a local ground-truth annotation 206(n). In various instances, each of the set of local ground-truth annotations 206 can be considered as the known result that would be obtained if a particular inferencing task (e.g., segmentation, classification, regression) were correctly or accurately performed on a respective one of the set of local training data candidates 204.

As a non-limiting example, the local training data candidates 204(1) can correspond to the local ground-truth annotation 206(1). Thus, the local ground-truth annotation 206(1) can be considered as the correct or accurate result that would be achieved if the particular inferencing task were properly performed on the local training data candidate 204(1). For instance, if the particular inferencing task is segmentation, then the local ground-truth annotation 206(1) can be the correct or accurate segmentation mask that is known or deemed to correspond to the local training data candidate 204(1). In another instance, if the particular inferencing task is classification, then the local ground-truth annotation 206(1) can be the correct or accurate classification label that is known or deemed to correspond to the local training data candidate 204(1). In yet another instance, if the particular inferencing task is regression, then the local ground-truth annotation 206(1) can be the correct or accurate continuous regression result that is known or deemed to correspond to the local training data candidate 204(1).

As another non-limiting example, the local training data candidates 204(n) can correspond to the local ground-truth annotation 206(n). So, the local ground-truth annotation 206(n) can be considered as the correct or accurate result (e.g., correct or accurate segmentation mask, correct or accurate classification label, correct or accurate regression result) that would be achieved if the particular inferencing task were properly performed on the local training data candidate 204(n).

Note that different ones of the set of local training datasets 106 can have the same or different counts as each other. For instance, FIG. 2 shows the local training dataset 202 as having a count of n (e.g., as having n total candidate-annotation pairs). Various other local training datasets can also have counts of n (e.g., can have their own n candidate-annotation pairs). However, in some cases, various other local training datasets can instead have counts greater than n or less than n.

Note that each of the set of local training datasets 106 can correspond or otherwise pertain to the same particular inferencing task as each other.

Referring back to FIG. 1, it can be desired to perform reprogrammable federated learning using the set of local training datasets 106, and thus among the set of clients 104. As described herein, the RFL server 102 can facilitate such reprogrammable federated learning.

In various embodiments, the RFL server 102 can comprise a processor 108 (e.g., computer processing unit, microprocessor) and a non-transitory computer-readable memory 110 that is operably or operatively or communicatively connected or coupled to the processor 108. The non-transitory computer-readable memory 110 can store computer-executable instructions which, upon execution by the processor 108, can cause the processor 108 or other components of the RFL server 102 (e.g., model component 112, training component 114) to perform one or more acts. In various embodiments, the non-transitory computer-readable memory 110 can store computer-executable components (e.g., model component 112, training component 114), and the processor 108 can execute the computer-executable components.

In various embodiments, the RFL server 102 can comprise a model component 112. In various aspects, as described herein, the model component 112 can electronically share a pre-trained, frozen neural network with the set of clients 104.

In various embodiments, the RFL server 102 can comprise a training component 114. In various instances, as described herein, the training component 114 can electronically orchestrate, conduct, or perform reprogrammable federated learning of the pre-trained, frozen neural network among the set of clients 104.

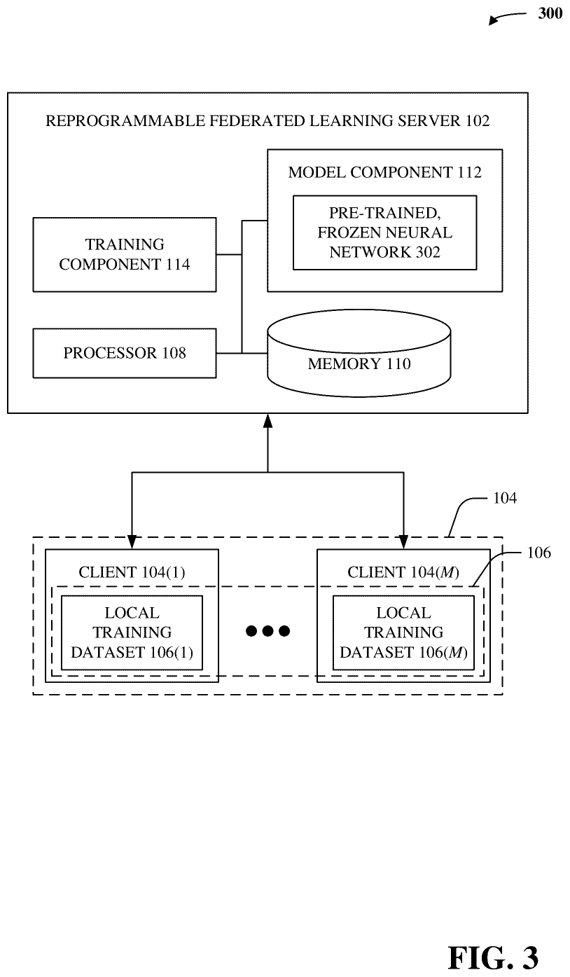

FIG. 3 illustrates a block diagram of an example, non-limiting system 300 including a pre-trained, frozen neural network that can facilitate reprogrammable federated learning in accordance with one or more embodiments described herein. As shown, the system 300 can, in some cases, comprise the same components as the system 100, and can further comprise a pre-trained, frozen neural network 302.

In various embodiments, the model component 112 can electronically store, electronically maintain, electronically control, or otherwise electronically access the pre-trained, frozen neural network 302. In various aspects, the pre-trained, frozen neural network 302 can have or otherwise exhibit any suitable internal architecture. For instance, the pre-trained, frozen neural network 302 can have an initial layer, one or more hidden layers, and a final layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such initial layer, one or more hidden layers, or final layer can be convolutional layers, whose learnable or trainable parameters can be convolutional kernels. As another example, any of such initial layer, one or more hidden layers, or final layer can be dense layers, whose learnable or trainable parameters can be weight matrices or bias values. As still another example, any of such initial layer, one or more hidden layers, or final layer can be batch normalization layers, whose learnable or trainable parameters can be shift factors or scale factors. Further still, in various cases, any of such layers can be any suitable types of neural network layers having any suitable fixed or non-trainable internal parameters. For example, any of such initial layer, one or more hidden layers, or final layer can be non-linearity layers, padding layers, pooling layers, or concatenation layers.

In various aspects, the pre-trained, frozen neural network 302 can have previously undergone any suitable type of training (e.g., supervised training, unsupervised training, reinforcement learning), so as to be configured to perform any suitable inferencing task. In some instances, the pre-trained, frozen neural network 302 can have been previously trained to perform the particular inferencing task to which each of the set of local training datasets 106 pertains. However, this is a mere non-limiting example. In other instances, the pre-trained, frozen neural network 302 can have been previously trained to perform some other inferencing task that is different from the particular inferencing task to which each of the set of local training datasets 106 pertains.

In any case, the RFL server 102 can orchestrate, as described herein and among the set of clients 104, reprogrammable federated learning with respect to the pre-trained, frozen neural network 302. Note that, during such reprogrammable federated learning, any internal parameters of the pre-trained, frozen neural network 302 can remain unchanged, unaltered, or unmodified, hence the term “frozen.” Contrast this with training-from-scratch or fine-tuning, in which at least some of such internal parameters would not be frozen.

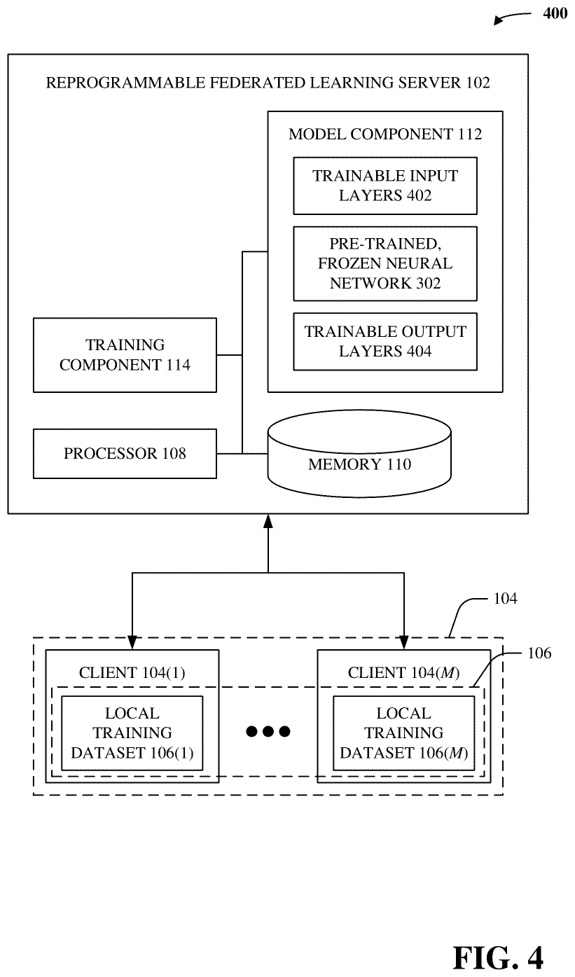

FIG. 4 illustrates a block diagram of an example, non-limiting system 400 including at least one trainable input layer and at least one trainable output layer that can facilitate reprogrammable federated learning in accordance with one or more embodiments described herein. As shown, the system 400 can, in some cases, comprise the same components as the system 300, and can further comprise one or more trainable input layers 402 and one or more trainable output layers 404.

In various embodiments, the model component 112 can electronically equip the pre-trained, frozen neural network 302 with the one or more trainable input layers 402 and with the one or more trainable output layers 404. In various instances, the one or more trainable input layers 402 can comprise any suitable number of any suitable types of neural network layers (e.g., convolutional layers, dense layers, non-linearity layers, pooling layers, batch normalization layers, padding layers) that can be coupled to each other via any suitable interlayer connections (e.g., forward connections, skip connections, recurrent connections). Similarly, the one or more trainable output layers 404 can comprise any suitable number of any suitable types of neural network layers (e.g., convolutional layers, dense layers, non-linearity layers, pooling layers, batch normalization layers, padding layers) that can be coupled to each other via any suitable interlayer connections (e.g., forward connections, skip connections, recurrent connections). In some aspects, the one or more trainable input layers and the one or more trainable output layers can exhibit the same or different internal architectures as each other.

In any case, the model component 112 can install or otherwise insert the one or more trainable input layers 402 at or before an upstream-end of the pre-trained, frozen neural network 302. Accordingly, any outputted activation maps that are produced by the one or more trainable input layers 402 can be fed into an initial layer of the pre-trained, frozen neural network 302. Similarly, the model component 112 can install or otherwise insert the one or more trainable output layers 404 at or after a downstream-end of the pre-trained, frozen neural network 302. Accordingly, any outputted activation maps that are produced by a final layer of the pre-trained, frozen neural network 302 can be fed into the one or more trainable output layers 404. Thus, the pre-trained, frozen neural network 302 can be considered as being coupled in series between the one or more trainable input layers 402 and the one or more trainable output layers 404. In other words, the pre-trained, frozen neural network 302 can be considered as being sandwiched in between the one or more trainable input layers 402 and the one or more trainable output layers 404.

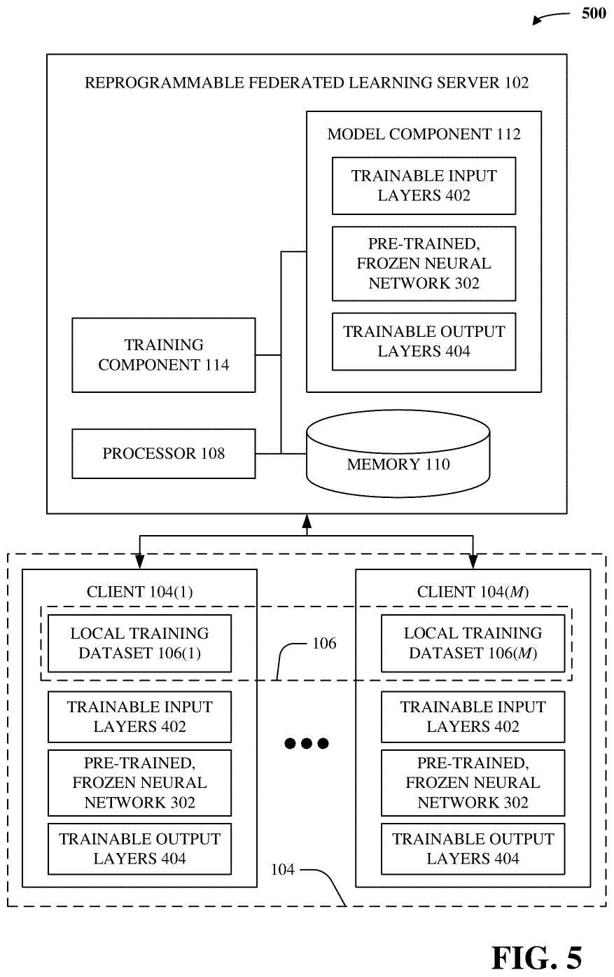

FIG. 5 illustrates a block diagram of an example, non-limiting system 500 in which a pre-trained, frozen neural network positioned between at least one trainable input layer and at least one trainable output layer has been shared among a set of clients in accordance with one or more embodiments described herein.

In various embodiments, as shown, the model component 112 can electronically share the pre-trained, frozen neural network 302, as coupled in series between the one or more trainable input layers 402 and the one or more trainable output layers 404, with each of the set of clients 104. In other words, the model component 112 can electronically transmit a respective copy of the one or more trainable input layers 402, of the pretrained, frozen neural network 302, and of the one or more trainable output layers 404 to each of the set of clients 104. Accordingly, each of the set of clients 104 can be considered as having or otherwise hosting its own local instance of the one or more trainable input layers 402, of the pretrained, frozen neural network 302, and of the one or more trainable output layers 404. As a non-limiting example, the client 104(1) can be considered as having or hosting a first instance of the pre-trained, frozen neural network 302 as sandwiched in between the one or more trainable input layers 402 and the one or more trainable output layers 404. As another non-limiting example, the client 104(m) can be considered as having or hosting an m-th instance of the pre-trained, frozen neural network 302 as sandwiched in between the one or more trainable input layers 402 and the one or more trainable output layers 404.

Based on the pre-trained, frozen neural network 302 being shared with the set of clients 104, the training component 114 can, in various aspects, begin performing any suitable number of iterations of reprogrammable federated learning.

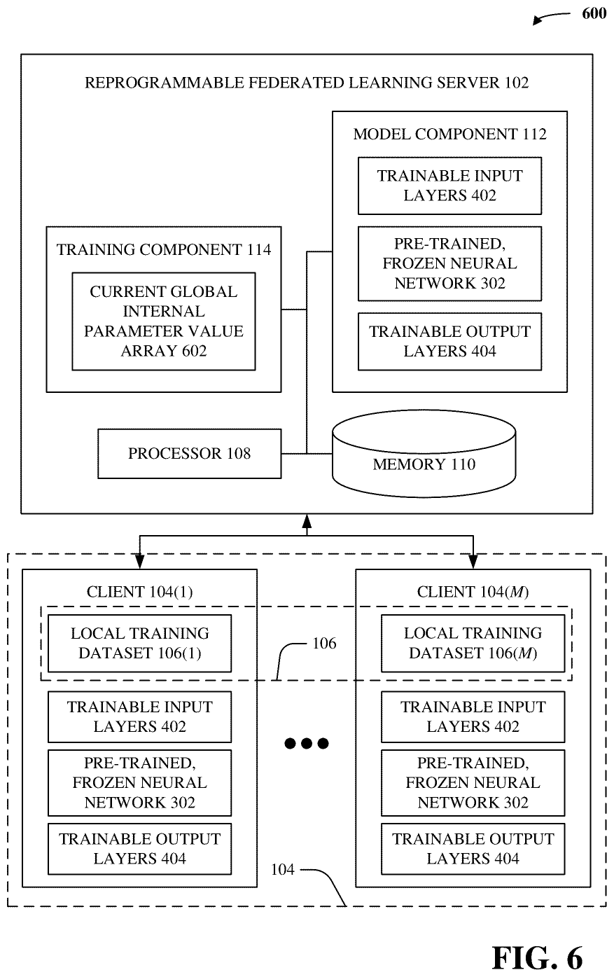

FIG. 6 illustrates a block diagram of an example, non-limiting system 600 including a current global internal parameter value array that can facilitate reprogrammable federated learning in accordance with one or more embodiments described herein. As shown, the system 600 can, in some cases, comprise the same components as the system 500, and can further comprise a current global internal parameter value array 602.

In various embodiments, the training component 114 can, during a current iteration of reprogrammable federated learning, electronically generate the current global internal parameter value array 602. In various aspects, the current global internal parameter value array 602 can be one or more scalars, one or more vectors, one or more matrices, one or more tensors, or any suitable combination thereof whose numerical elements can indicate or otherwise specify values or magnitudes that are assignable to the various trainable internal parameters of the one or more trainable input layers 402 and of the one or more trainable output layers 404. As a non-limiting example, the one or more trainable input layers 402 and the one or more trainable output layers 404 can include any suitable number of trainable weight matrices. In such case, the current global internal parameter value array 602 can indicate or specify numerical values that can be respectively assigned to those trainable weight matrices. As another non-limiting example, the one or more trainable input layers 402 and the one or more trainable output layers 404 can include any suitable number of trainable biases. In such case, the current global internal parameter value array 602 can indicate or specify numerical values that can be respectively assigned to those trainable biases. As even another non-limiting example, the one or more trainable input layers 402 and the one or more trainable output layers 404 can include any suitable number of trainable convolutional kernels. In such case, the current global internal parameter value array 602 can indicate or specify numerical values that can be respectively assigned to those trainable convolutional kernels. As yet another non-limiting example, the one or more trainable input layers 402 and the one or more trainable output layers 404 can include any suitable number of trainable scaling/shifting factors. In such case, the current global internal parameter value array 602 can indicate or specify numerical values that can be respectively assigned to those trainable scaling/shifting factors.

In some aspects, the current iteration of reprogrammable federated learning might be the very first or initial iteration. In such case, the training component 114 can randomly generate the current global internal parameter value array 602. In other aspects, the current iteration of reprogrammable federated learning might not be the very first or initial iteration. In such case, the current global internal parameter value array 602 can be equal to or otherwise based on a new global internal parameter value array that was generated by the training component 114 during an immediately previous iteration of reprogrammable federated learning.

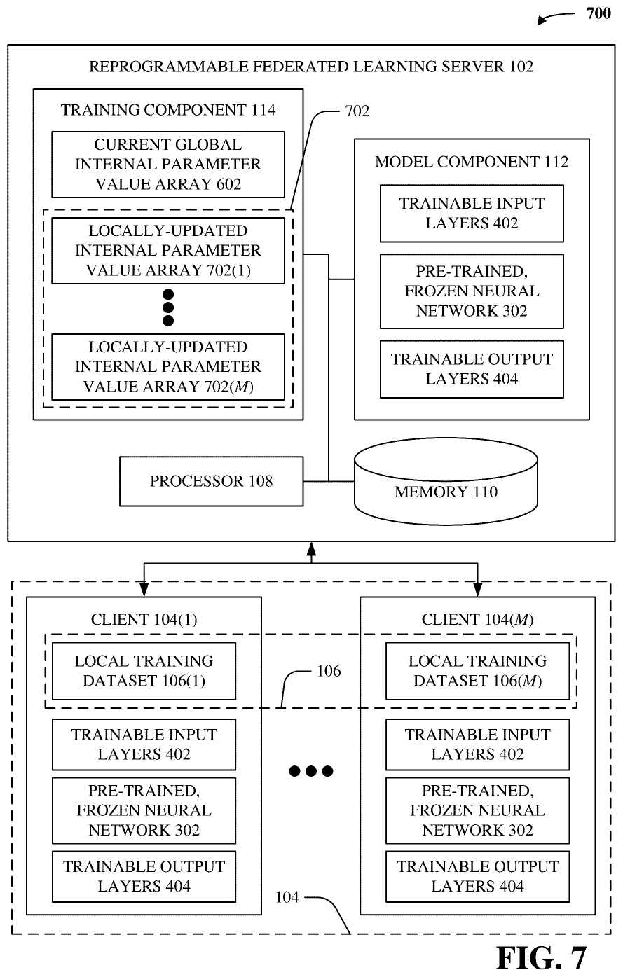

FIG. 7 illustrates a block diagram of an example, non-limiting system 700 including a set of locally-updated internal parameter value arrays that can facilitate reprogrammable federated learning in accordance with one or more embodiments described herein. As shown, the system 700 can, in some cases, comprise the same components as the system 600, and can further comprise a set of locally-updated internal parameter value arrays 702.

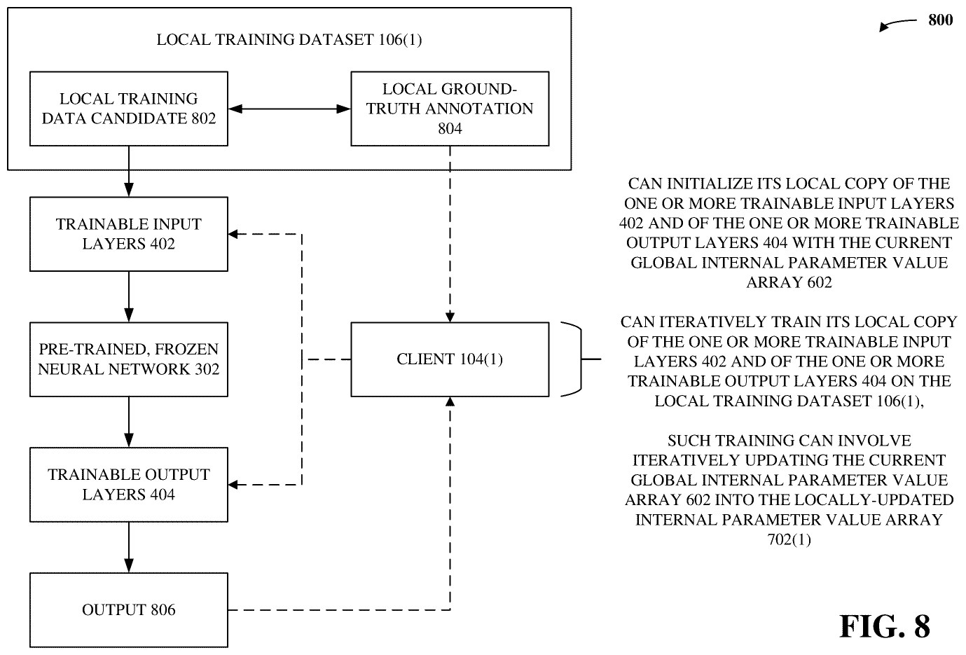

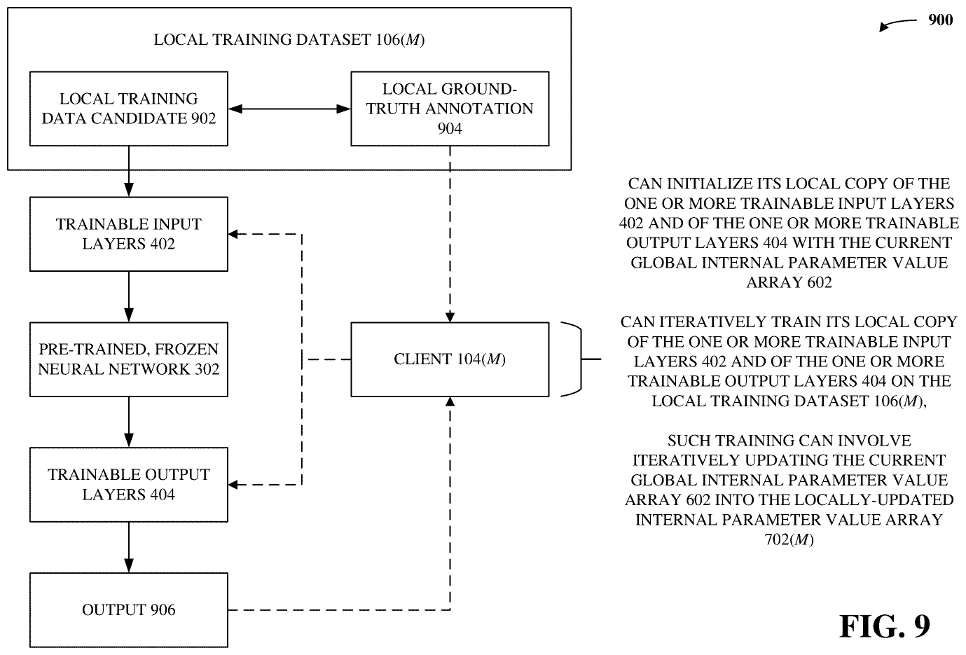

In various embodiments, the training component 114 can electronically transmit the current global internal parameter value array 602 to each of the set of clients 104. In various aspects, such transmission can be considered, treated, or otherwise interpreted as an instruction to perform local training of the one or more trainable input layers 402 and of the one or more trainable output layers 404, using the current global internal parameter value array 602 as a training initialization. Accordingly, the set of clients 104 can respond to such transmission by performing such local training. In various instances, such local training can involve each of the set of clients 104 making local updates to the current global internal parameter value array 602. As a non-limiting example, the client 104(1) can make its own numerical updates to the current global internal parameter value array 602, which can yield a locally-updated internal parameter value array 702(1). In various cases, the locally-updated internal parameter value array 702(1), which can have the same format, size, or dimensionality as the current global internal parameter value array 602, can be considered as a first updated version of the current global internal parameter value array 602. As another non-limiting example, the client 104(m) can make its own numerical updates to the current global internal parameter value array 602, which can yield a locally-updated internal parameter value array 702(m). In various cases, the locally-updated internal parameter value array 702(m), which can have the same format, size, or dimensionality as the current global internal parameter value array 602, can be considered as an m-th updated version of the current global internal parameter value array 602. In various instances, the locally-updated internal parameter value array 702(1) to the locally-updated internal parameter value array 702(m) can collectively be considered as forming the set of locally-updated internal parameter value arrays 702. Various non-limiting aspects are described with respect to FIGS. 8-9.

FIGS. 8-9 illustrate example, non-limiting block diagrams 800 and 900 showing how the set of locally-updated internal parameter value arrays 702 can be obtained in accordance with one or more embodiments described herein.

First, consider FIG. 8. As shown, FIG. 8 pertains to the client 104(1). In various aspects, as mentioned above, the training component 114 can transmit the current global internal parameter value array 602 to the client 104(1). In response to such transmission, the client 104(1) can electronically initialize the trainable internal parameters of its local instance of the one or more trainable input layers 402 and of the one or more trainable output layers 404 according to the current global internal parameter value array 602. That is, the client 104(1) can cause the weight matrices, the biases, the convolutional kernels, or the scaling/shifting factors that make up its local copy of the one or more trainable input layers 402 and that make up its local copy of the one or more trainable output layers 404 to take on whatever respective numerical values are specified in the current global internal parameter value array 602. After such initialization, the client 104(1) can perform any suitable number of local training iterations on its local copy of the one or more trainable input layers 402 and the one or more trainable output layers 404.

For example, the client 104(1) can select from the local training dataset 106(1) a local training data candidate 802 and a local ground-truth annotation 804 that corresponds to the local training data candidate 802. In various aspects, the client 104(1) can execute its local instance/copy of the pre-trained, frozen neural network 302, as coupled in series between the one or more trainable input layers 402 and the one or more trainable output layers 404, on the local training data candidate 802. Such execution can yield an output 806.

More specifically, the client 104(1) can feed the local training data candidate 802 to the one or more trainable input layers 402. The local training data candidate 802 can accordingly complete a forward pass through the one or more trainable input layers 402. Although not explicitly shown in FIG. 8 for sake of space, such forward pass can cause the one or more trainable input layers 402 to produce as output any suitable first activation maps or feature maps. In various instances, the client 104(1) can feed such first activation maps or feature maps to the pre-trained, frozen neural network 302. Such first activation maps or feature maps can thus complete a forward pass through the pre-trained, frozen neural network 302 (e.g., through an initial layer, through one or hidden layers, and through a final layer of the pre-trained, frozen neural network 302). Although not explicitly shown in FIG. 8 for sake of space, such forward pass can cause the pre-trained, frozen neural network 302 to produce as output any suitable second activation maps or feature maps. In various cases, the client 104(1) can feed such second activation maps or feature maps to the one or more trainable output layers 404. Such second activation maps or feature maps can accordingly complete a forward pass through the one or more trainable output layers 404. Such forward pass can cause the one or more trainable output layers 404 to produce the output 806. In other words, the output 806 can be considered as whatever activation maps or feature maps are produced as output by the one or more trainable output layers 404.

In various aspects, the output 806 can have the same format, size, or dimensionality as the local ground-truth annotation 804. That is, the output 806 can be considered as being the predicted inferencing task result (e.g., predicted segmentation mask, predicted classification label, predicted regression result) that the one or more trainable input layers 402, that the pre-trained, frozen neural network 302, and that the one or more trainable output layers 404 collectively determined should correspond to the local training data candidate 802. In contrast, the local ground-truth annotation 804 can be considered as the correct or accurate inferencing task result (e.g., correct/accurate segmentation mask, correct/accurate classification label, correct/accurate regression result) that is known or deemed to correspond to the local training data candidate 802. Accordingly, the client 104(1) can compute an error (e.g., mean absolute error (MAE), mean squared error (MSE), cross-entropy) between the output 806 and the local ground-truth annotation 804. In various cases, the client 104(1) can incrementally update, via backpropagation (e.g., via DP-SGD), the trainable internal parameters (e.g., the weight matrices, the biases, the convolutional kernels, the scaling/shifting factors) that make up its local instance of the one or more trainable input layers 402 and the one or more trainable output layers 404, based on such error. In other words, the client 104(1) can incrementally update the current global internal parameter value array 602. Note, however, that the client 104(1) can refrain from updating, modifying, altering, or otherwise changing any of the trainable internal parameters (e.g., the weight matrices, the biases, the convolutional kernels, the scaling/shifting factors) that make up its local instance of the pre-trained, frozen neural network 302, hence the term “frozen”.

Although this example describes the client 104(1) as utilizing a training batch size of one, this is a mere non-limiting example for ease of explanation. In various cases, the client 104(1) can utilize any suitable training batch sizes.

In any case, the client 104(1) can locally update the current global internal parameter value array 602 in this fashion for any suitable number of local training iterations (e.g., until any suitable local training termination criterion is achieved), all of which can be considered as occurring during the current iteration of reprogrammable federated learning. At the completion of such local training, the most recently updated version of the current global internal parameter value array 602 that was produced by the client 104(1) can be considered or otherwise treated as the locally-updated internal parameter value array 702(1). In various aspects, the client 104(1) can electronically transmit the locally-updated internal parameter value array 702(1) to the training component 114.

Now, consider FIG. 9. As shown, FIG. 9 pertains to the client 104(m). In various aspects, as mentioned above, the training component 114 can transmit the current global internal parameter value array 602 to the client 104(m). In response to such transmission, the client 104(m) can electronically initialize the trainable internal parameters of its local instance of the one or more trainable input layers 402 and of the one or more trainable output layers 404 according to the current global internal parameter value array 602. That is, the client 104(m) can cause the weight matrices, the biases, the convolutional kernels, or the scaling/shifting factors that make up its local copy of the one or more trainable input layers 402 and that make up its local copy of the one or more trainable output layers 404 to take on whatever respective numerical values are specified in the current global internal parameter value array 602. After such initialization, the client 104(m) can then perform any suitable number of local training iterations on its local copy of the one or more trainable input layers 402 and the one or more trainable output layers 404.

For example, the client 104(m) can select from the local training dataset 106(m) a local training data candidate 902 and a local ground-truth annotation 904 that corresponds to the local training data candidate 902. In various aspects, the client 104(m) can execute its local instance/copy of the pre-trained, frozen neural network 302, as coupled in series between the one or more trainable input layers 402 and the one or more trainable output layers 404, on the local training data candidate 902. Such execution can yield an output 906.

More specifically, the client 104(m) can feed the local training data candidate 902 to the one or more trainable input layers 402. The local training data candidate 902 can accordingly complete a forward pass through the one or more trainable input layers 402. Although not explicitly shown in FIG. 9 for sake of space, such forward pass can cause the one or more trainable input layers 402 to produce as output any suitable third activation maps or feature maps. In various instances, the client 104(m) can feed such third activation maps or feature maps to the pre-trained, frozen neural network 302. Such third activation maps or feature maps can thus complete a forward pass through the pre-trained, frozen neural network 302 (e.g., through an initial layer, through one or hidden layers, and through a final layer of the pre-trained, frozen neural network 302). Although not explicitly shown in FIG. 9 for sake of space, such forward pass can cause the pre-trained, frozen neural network 302 to produce as output any suitable fourth activation maps or feature maps. In various cases, the client 104(m) can feed such fourth activation maps or feature maps to the one or more trainable output layers 404. Such fourth activation maps or feature maps can accordingly complete a forward pass through the one or more trainable output layers 404. Such forward pass can cause the one or more trainable output layers 404 to produce the output 906. In other words, the output 906 can be considered as whatever activation maps or feature maps are produced as output by the one or more trainable output layers 404.

In various aspects, the output 906 can have the same format, size, or dimensionality as the local ground-truth annotation 904. That is, the output 906 can be considered as being the predicted inferencing task result (e.g., predicted segmentation mask, predicted classification label, predicted regression result) that the one or more trainable input layers 402, that the pre-trained, frozen neural network 302, and that the one or more trainable output layers 404 collectively determined should correspond to the local training data candidate 902. In contrast, the local ground-truth annotation 904 can be considered as the correct or accurate inferencing task result (e.g., correct/accurate segmentation mask, correct/accurate classification label, correct/accurate regression result) that is known or deemed to correspond to the local training data candidate 902. Accordingly, the client 104(m) can compute an error (e.g., MAE, MSE, cross-entropy) between the output 906 and the local ground-truth annotation 904. In various cases, the client 104(m) can incrementally update, via backpropagation (e.g., via DP-SGD), the trainable internal parameters (e.g., the weight matrices, the biases, the convolutional kernels, the scaling/shifting factors) that make up its local instance of the one or more trainable input layers 402 and the one or more trainable output layers 404, based on such error. In other words, the client 104(m) can incrementally update the current global internal parameter value array 602. Note, however, that the client 104(m) can refrain from updating, modifying, altering, or otherwise changing any of the trainable internal parameters (e.g., the weight matrices, the biases, the convolutional kernels, the scaling/shifting factors) that make up its local instance of the pre-trained, frozen neural network 302, hence the term “frozen”.

Although this example describes the client 104(m) as utilizing a training batch size of one, this is a mere non-limiting example for ease of explanation. In various cases, the client 104(m) can utilize any suitable training batch sizes.

In any case, the client 104(m) can locally update the current global internal parameter value array 602 in this fashion for any suitable number of local training iterations (e.g., until any suitable training termination criterion is achieved), all of which can be considered as occurring during the current iteration of reprogrammable federated learning. At the completion of such local training, the most recently updated version of the current global internal parameter value array 602 that was produced by the client 104(m) can be considered or otherwise treated as the locally-updated internal parameter value array 702(m). In various aspects, the client 104(m) can electronically transmit the locally-updated internal parameter value array 702(m) to the training component 114.

In this way, the training component 114 can obtain, during the current iteration of reprogrammable federated learning, the set of locally-updated internal parameter value arrays 702.

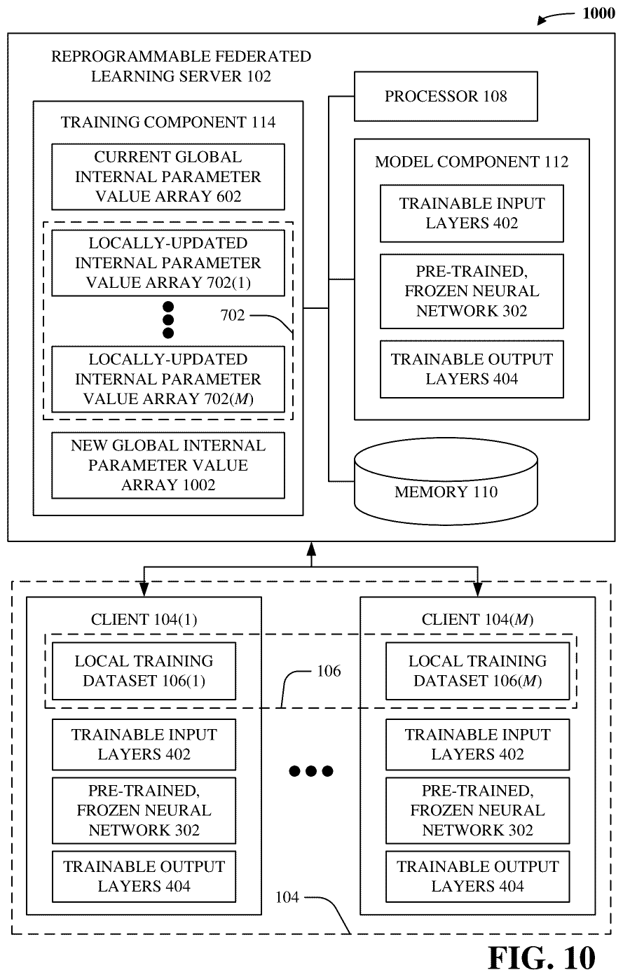

FIG. 10 illustrates a block diagram of an example, non-limiting system 1000 including a new global internal parameter value array that can facilitate reprogrammable federated learning in accordance with one or more embodiments described herein. As shown, the system 1000 can, in some cases, comprise the same components as the system 700, and can further comprise a new global internal parameter value array 1002.

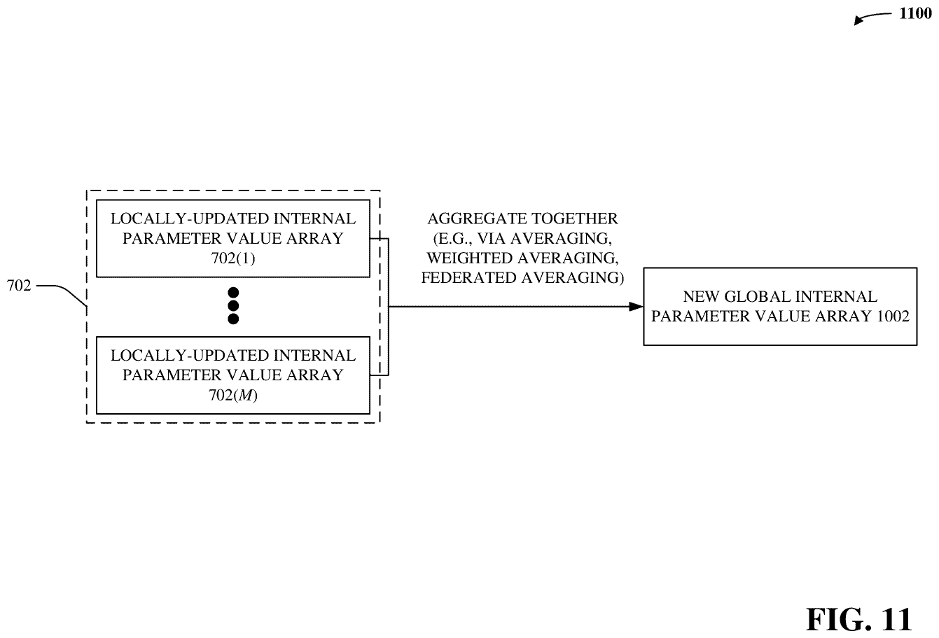

In various embodiments, the training component 114 can electronically generate, during the current iteration of reprogrammable federated learning, the new global internal parameter value array 1002, based on the set of locally-updated internal parameter value arrays 702. Non-limiting aspects are described with respect to FIG. 11.

FIG. 11 illustrates an example, non-limiting block diagram 1100 showing how the new global internal parameter value array 1002 can be obtained from the set of locally-updated internal parameter value arrays 702 in accordance with one or more embodiments described herein.

In various aspects, as shown, the new global internal parameter value array 1002 (which can have the same format, size, or dimensionality as the current global internal parameter value array 602) can be equal to or otherwise based on an aggregation of the set of locally-updated internal parameter value arrays 702. In various instances, the training component 114 can implement any suitable aggregation technique when generating the new global internal parameter value array 1002. As a non-limiting example, the new global internal parameter value array 1002 can be equal to or otherwise based on a non-weighted average of the set of locally-updated internal parameter value arrays 702. As another non-limiting example, the new global internal parameter value array 1002 can be equal to or otherwise based on a weighted average of the set of locally-updated internal parameter value arrays 702. As even another non-limiting example, the new global internal parameter value array 1002 can be equal to or otherwise based on a federated average of the set of locally-updated internal parameter value arrays 702.

In any case, the training component 114 can generate the new global internal parameter value array 1002 during the current iteration of reprogrammable federated learning. In various aspects, the new global internal parameter value array 1002 can be considered or treated as the current global internal parameter value array 602 during a succeeding or next iteration of reprogrammable federated learning. In various instances, the training component 114 can perform any suitable number of iterations of reprogrammable federated learning in this fashion (e.g., until any suitable training termination criterion is achieved). For example, the training component 114 can perform as many iterations of reprogrammable federated learning until any suitable privacy budget associated with the pre-trained, frozen neural network 302 has been depleted or consumed. In any case, upon complete of the last or final iteration of reprogrammable federated learning, the most recent version of the new global internal parameter value array 1002 can be considered or treated as the fully trained parameters for the one or more trainable input layers 402 and the one or more trainable output layers 404. Accordingly, the training component 114 can share such most recent version of the new global internal parameter value array 1002 with each of the set of clients 104, so that each of the set of clients 104 can subsequently deploy the fully trained version of the one or more trainable input layers 402 and of the one or more trainable output layers 404.

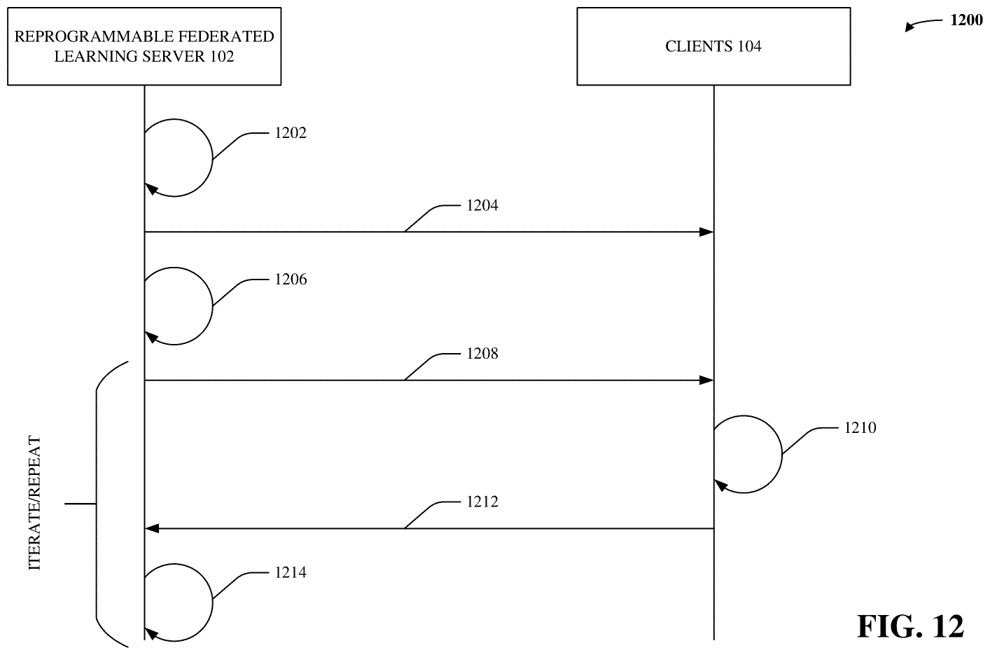

FIG. 12 illustrates an example, non-limiting communication diagram 1200 associated with reprogrammable federated learning in accordance with one or more embodiments described herein.

In various embodiments, the RFL server 102 can, at act 1202, equip the pre-trained, frozen neural network 302 with the one or more trainable input layers 402 and with the one or more trainable output layers 404.

In various aspects, the RFL server 102 can, at act 1204, distribute the pre-trained, frozen neural network 302, as equipped with the one or more trainable input layers 402 and with the one or more trainable output layers 404, to each of the set of clients 104.

In various instances, the RFL server 102 can, at act 1206, randomly initialize the current global internal parameter value array 602.

In various cases, the RFL server 102 can, at act 1208, instruct each of the set of clients 104 to locally train their local copies of the one or more trainable input layers 402 and the one or more trainable output layers 404, by using the current global internal parameter value array 602 as a parameter initialization.

In various aspects, the set of clients 104 can, at act 1210, perform such local training, thereby yielding the set of locally-updated internal parameter value arrays 702.

In various instances, the set of clients 104 can, at act 1212, respectively transmit the set of locally-updated internal parameter value arrays 702 to the RFL server 102.

In various cases, the RFL server 102 can, at act 1214, aggregate the set of locally-updated internal parameter value arrays 702, thereby yielding the new global internal parameter value array 1002.

In various aspects, acts 1208-1214 can be iterated or repeated for any suitable number of times. In any given one of such iterations or repetitions, the current global internal parameter value array 602 that is transmitted in act 1208 can be equal to the new global internal parameter value array 1002 that was generated during the previous performance of act 1214.

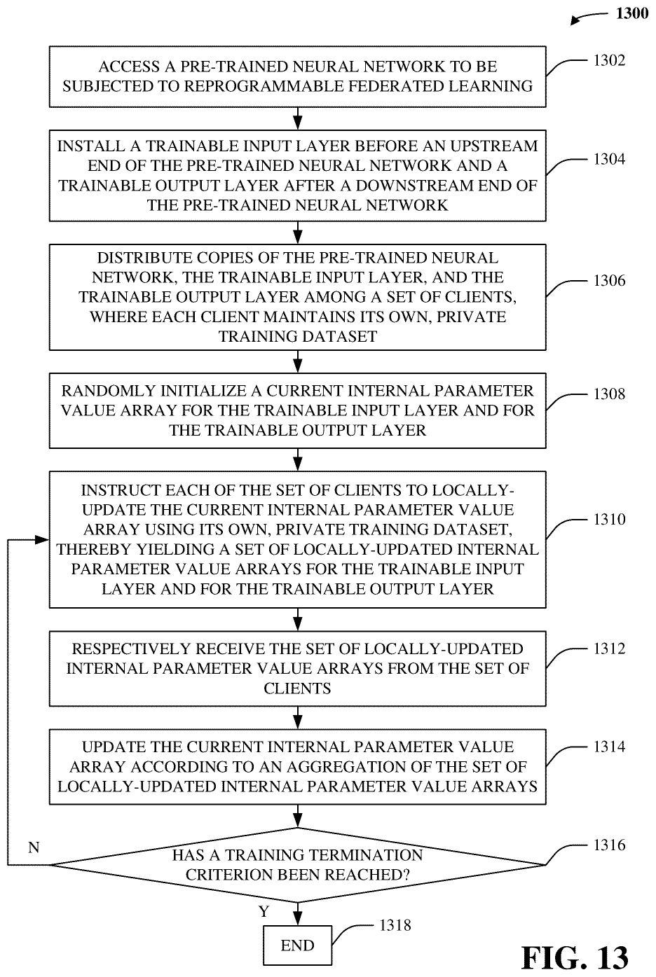

FIG. 13 illustrates a flow diagram of an example, non-limiting computer-implemented method 1300 that can facilitate reprogrammable federated learning in accordance with one or more embodiments described herein. In various aspects, the RFL server 102 can facilitate the computer-implemented method 1300.

In various embodiments, act 1302 can include accessing, by a device (e.g., via 112) operatively coupled to a processor (e.g., 108), a pre-trained neural network (e.g., 302) to be subjected to reprogrammable federated learning.

In various aspects, act 1304 can include installing, by the device (e.g., via 112), a trainable input layer (e.g., 402) before an upstream end of the pre-trained neural network and a trainable output layer (e.g., 404) after a downstream end of the pre-trained neural network.

In various instances, act 1306 can include distributing, by the device (e.g., via 112), copies of the pre-trained neural network, the trainable input layer, and the trainable output layer among a set of clients (e.g., 104), where each client can maintain its own, private training dataset (e.g., 106).

In various cases, act 1308 can include randomly initializing, by the device (e.g., via 114), a current internal parameter value array (e.g., 602) for the trainable input layer and for the trainable output layer.

In various aspects, act 1310 can include instructing, by the device (e.g., via 114), each of the set of clients to locally-update the current internal parameter value array using its own, private training dataset. This can yield a set of locally-updated internal parameter value arrays (e.g., 702) for the trainable input layer and for the trainable output layer.

In various instances, act 1312 can include respectively receiving, by the device (e.g., via 114), the set of locally-updated internal parameter value arrays from the set of clients.

In various cases, act 1314 can include updating, by the device (e.g., via 114), the current internal parameter value array according to an aggregation of the set of locally-updated internal parameter value arrays.

In various aspects, act 1316 can include determining, by the device (e.g., via 114) whether a training termination criterion (e.g., privacy budget) has been reached. If so, the computer-implemented method 1300 can end at act 1318. If not, the computer-implemented method 1300 can proceed back to act 1310.

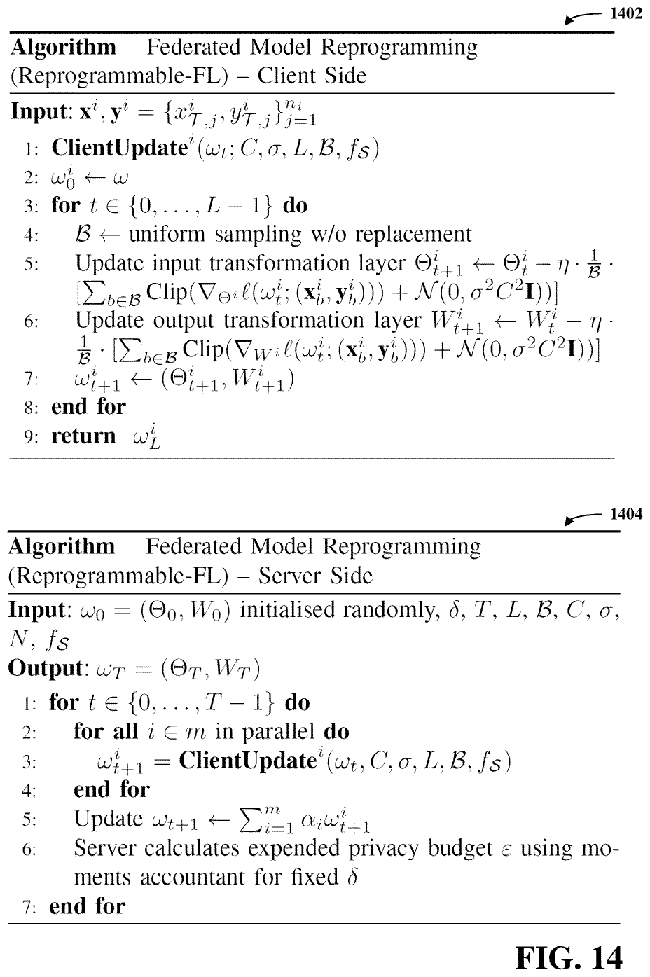

FIG. 14 illustrates example, non-limiting algorithms 1402 and 1404 that can facilitate reprogrammable federated learning in accordance with one or more embodiments described herein. Various non-limiting aspects are described with respect to FIG. 14 using mathematical notation.

In model reprogram (MR), a pre-trained source model (e.g., 302) can be adapted for use in a new domain (e.g., a target domain) by the addition of input and output transformation layers (e.g., 402 and 404). The internal parameters of the source model can be frozen after training on a source task in a source domain, and the internal parameters of the input and output transformation layers can be learned to map, respectively, inputs in the target domain to inputs in the source domain and outputs in the source domain to outputs in the target domain.

Without loss of generality, it can be assumed that the inputs and outputs for the source and target tasks are vectors of dimension [symbol] and [symbol] , respectively. It can be the case that [symbol] ≤ [symbol] . For purposes of explanation, it can also be assumed that the two tasks under consideration are classification tasks, with [symbol] target classes and with [symbol] source classes such that [symbol] ≤ [symbol] . However, this is a mere non-limiting example. In various aspects, the herein described teachings can be applied to non-classification tasks (e.g., to segmentation, to regression).

In various instances, the input transformation layer (e.g., 402) can map a sample [symbol] in the input space of the target task to a point [symbol] in the input space of the source task, while including learned parameters in [symbol] that assist in partially adapting the source model to the target task. In the case of a scaled input range [−1,1] in each input dimension, the input transformation layer can be a padding layer, such that:

$${\tilde{x}}_{𝒯} = Zero Padding ( {x}_{𝒯} ) + tanh ( M ⊙ Θ )$$

where the operator ZeroPadding can add borders of zeros around [symbol] to cause [symbol] to be of size [symbol] , and where M can be a binary mask that equals zero wherever ZeroPadding ( [symbol] ) is equal to [symbol] and that equals one on the border of ZeroPadding ( [symbol] ). Here, Θ can be a learnable internal parameter which can be considered as an input-independent perturbation of the padded input sample that can help to adapt the source model to the target task. Lastly, tanh can be the element-wise hyperbolic tangent function which can ensure each dimension of [symbol] stays within [−1,1].

In various aspects, the output transformation layer (e.g., 404) can map [symbol] classes to [symbol] classes through a trainable fully-connected layer parameterized by W. This mapping between the logit outputs of the source model, [symbol] = [symbol] ( [symbol] ) where [symbol] represents the source model, and the logits of the target task, [symbol] , can be denoted as [symbol] =F_{c}(W, [symbol] ), where F_{c} can denote the fully-connected output layer. In various cases, the softmax function can be applied, such that the final prediction can be given by:

$${\hat{y}}_{𝒯} = softmax [ {F}_{c} ( W , {\hat{y}}_{𝒮} ) ]$$

When given the pre-trained source model [symbol] and a target training set { [symbol] }ᵢ₌₁ⁿ comprising n candidate-annotation pairs for any suitable positive integer n, the reprogramming parameters Θ and W can be learned as minimizers of:

$$f ( Θ , W ) = \frac{1}{n} {\sum }_{i = 1}^{n} ℓ ( {\hat{y}}_{𝒯}^{i} ( {f}_{𝒮} ( {\tilde{x}}_{𝒯}^{i} ) ) , {y}_{𝒯}^{i} )$$

where [symbol] can be any suitable error or loss function (e.g., MAE, MSE, cross-entropy).

As mentioned above, federated learning is a machine learning paradigm that allows multiple clients (e.g., 104) to collaboratively train a model in a distributed manner without sharing training data. Let fᵢ(ω) measure the loss of the shared model ω on the i-th client for any suitable positive integer i. In such case, federated learning can be considered as attempting to minimize the weighted global loss:

$$F ( ω ) = {\sum }_{i = 1}^{m} {α}_{i} {f}_{i} ( ω )$$

while minimizing communication and data exposure between the clients, where αᵢ=nᵢ/N can denote the fraction of the overall training data that is present on the i-th client, where nᵢ can denote the number of training samples on the i-th client, where N can be the total number of samples used during the federated learning process, and where m can denote the total number of clients. Typically, fᵢ can measure the performance of the model on the training dataset local to the i-th client. As a non-limiting example,

$${f}_{i} ( ω ) = {\sum }_{j = 1}^{{n}_{i}} ℓ ( ω ; ( {x}_{j}^{i} , {y}_{j}^{i} ) )$$

To achieve the goals of minimizing communication and data exposure, federated learning can alternate between aggregating local models to form a global model and locally updating the global model at each client to form more accurate local models. As a non-limiting example, federated averaging (FedAvg) forms the t-th global model ωₜ as an average over the local models ωₜⁱ. That is, ωₜ=Σᵢ₌₁^{m}αᵢωₜⁱ. The local models ωₜⁱ can be obtained by using multiple steps of SGD on each client to update the previous global model ωₜ₋₁ to minimize fᵢ. This process can be continued until model convergence.

DP-SGD can be implemented instead of SGD to help preserve data privacy. A randomized algorithm [symbol] can be said to be (ε, δ) differentially private if it guarantees that for any two training datasets [symbol] and [symbol] ′ that differ by the inclusion or exclusion of a single training sample, and any set S in the output space:

$$𝒫 [ 𝒜 ( 𝒟 ) ∈ 𝒮 ] \leq exp ( ε ) 𝒫 [ 𝒜 ( {𝒟}^{′} ) ∈ 𝒮 ] + δ$$

When [symbol] is in the training dataset and [symbol] is the algorithm used to train a machine learning model, this guarantee ensures that even if all the other data points utilized in fitting a model are known, one cannot infer the presence or absence of a particular individual data point from the learned model because the models [symbol] ( [symbol] ) and [symbol] ( [symbol] ′) are very likely to be similar. Smaller values of ε and δ give stronger privacy guarantees.

DP-SGD can be considered as modifying SGD by using the Gaussian mechanism to lower disclosure risk. In particular, let g be a deterministic vector-valued query function that takes a dataset as input, and define its sensitivity S_{g} as the maximum of ∥g( [symbol] )−g( [symbol] ′)∥₂ over adjacent datasets. The Gaussian mechanism can be considered as using the following as a private proxy for g( [symbol] ):

$$g ( 𝒟 ) + 𝒩 ( 0 , {S}_{g}^{2} {σ}^{2} I )$$

where [symbol] (0, S_{g}²σ²I) can denote zero-mean Gaussian noise with the given covariance matrix. Intuitively, the addition of noise calibrated to the sensitivity level of the query function can hide the influence of any one particular data point. More precisely, given ε ∈ (0,1) and δ ∈ (0,1), it can suffice to take δ>2ε⁻¹ln(1.25δ⁻¹) for this proxy for g to be (ε, δ) differentially private.

In the application of the Gaussian mechanism to DP-SGD, the query function g can be the SGD gradient estimator evaluated on the training dataset, and its sensitivity can be naturally bounded by the [symbol] ₂ norm of the largest gradient on any of the training data points. This quantity can be unknown, can change over time, and can be prohibitively large. So, in DP-SGD, the sensitivity of the gradient estimator can be fixed at a hyperparameter C by passing it through the Clip operator:

$$Clip ( x ) = \frac{x}{max \{ 1 , {‖ x ‖}_{2} / C \}}$$

In various aspects, the moment accounts technique can be implemented to track the evolution of the privacy parameters (ε, δ) during DP-SGD training.

In various aspects, as described herein, model reprogramming can be implemented in the context of federated learning that utilizes DP-SGD. This can be referred to as reprogrammable differentially private federated learning. In particular, when given the mathematical notation mentioned above, the algorithm 1402 can be considered as illustrating the operations of each client (e.g., 104) during reprogrammable differentially private federated learning, and the algorithm 1404 can be considered as illustrating the operations of a central server (e.g., 102) during reprogrammable differentially private federated learning.

More specifically, a pre-trained source model [symbol] (e.g., 302) can be distributed to each of the clients (e.g., 104) before the start of reprogrammable differentially private federated learning. At the start of each communication iteration, the central server can communicate the current global reprogramming parameters ω={Θ, W} (e.g., 602) to all clients. Recall that Θ and W denote the trainable internal parameters of the input and output transformation layers, respectively. In various aspects, DP-SGD, as shown in lines 4-7 of the algorithm 1402, can be used locally to obtain updated local reprogramming parameters that improve performance on the local training data. The clients can then return their locally-updated reprogramming parameters (e.g., 702) to the central server, which can aggregate them together to compute the latest global model (e.g., 1002).

Consider a setting of m clients where the private data on the i-th client with nᵢ samples can be denoted by:

$${x}^{i} , {y}^{i} = {\{ {x}_{𝒯 , j}^{i} , {y}_{𝒯 , j}^{i} \}}_{j = 1}^{{n}_{i}}$$

Here, the subscript [symbol] can indicate that samples from the target domain are used for local training, and the subscript j can indicate a specific training sample. Now, consider the training procedure of one client. At the beginning of each iteration, the client can receive the latest global model and can then train for L local iterations, for any suitable positive integer L. In each local iteration, the client can sample a batch [symbol] uniformly at random from the local training dataset and can update the local reprogramming parameters using DP-SGD. However, this is a mere non-limiting example. In various embodiments, any other suitable optimization technique can be implemented instead of DP-SGD. In any case, when the local training ends, each client can send their local reprogramming parameters ω_{L}={Θ_{L}, W_{L}} back to the central server. Note that, for clarity, the loss function of the i-th client is abbreviated in the algorithm 1402 as:

$$ℓ ( ω ; ( {x}_{b}^{i} , {y}_{b}^{i} ) ) = ℓ ( \hat{y} ( {f}_{𝒮} ( {\tilde{x}}_{b}^{i} ) ) , {y}_{b}^{i} )$$

where the subscript b can denote the b-th sample from the current batch of local data, and where \tilde{x}_{b}ⁱ and ŷ can be computed using the current local reprogramming parameters.

Now, consider the server-side computations of reprogrammable differentially private federated learning, as shown in the algorithm 1404. The clients can train their local models in a parallel manner and can then send the trained layer parameters {ω_{L}ⁱ}ᵢ₌₁ⁿ back to the central server n after the local training procedures conclude. The central server can aggregate the local models to form the next global model, which can then be sent back to the clients. Training can continue in this fashion for T iterations, for any suitable positive integer T. Given a fixed δ and a noise variance σ, the central server can use the moment accounts technique at each iteration t to compute the expended privacy budget so far by all the clients over the entire dataset, ε. This computation can utilize knowledge of the total number of iterations over the full dataset, t×L, and total effective batch size m× [symbol] .

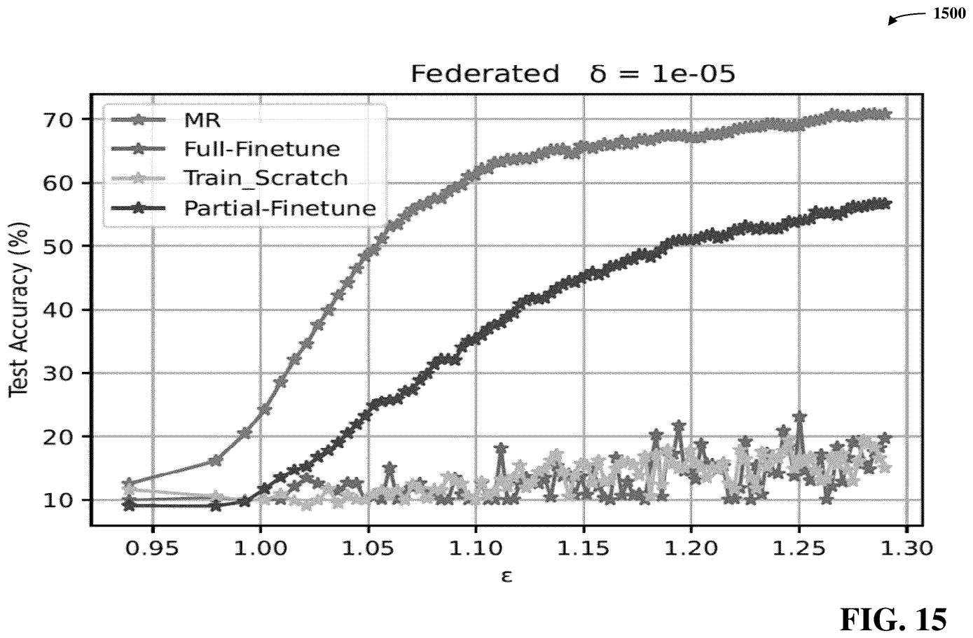

To show technical benefits of various embodiments described herein, the present inventors conducted various experiments, results of which are illustrated in FIGS. 15-17.

First, consider FIG. 15. A source neural network was obtained, and federated learning with respect to the source neural network was experimentally performed in four separate fashions: (1) reprogrammable fashion as described herein (e.g., denoted “MR” in FIGS. 15-17); (2) training-from-scratch fashion; (3) full fine-tuning fashion; and (4) partial fine-tuning fashion. FIG. 15 shows a graph 1500 that plots test accuracy versus privacy budget for such experiments. As shown, reprogrammable federated learning (“MR”) achieved significantly higher accuracy at each privacy budget as compared to training-from-scratch and full fine-tuning. As also shown, reprogrammable federated learning even achieved significantly higher accuracy at each privacy budget as compared to partial fine-tuning.

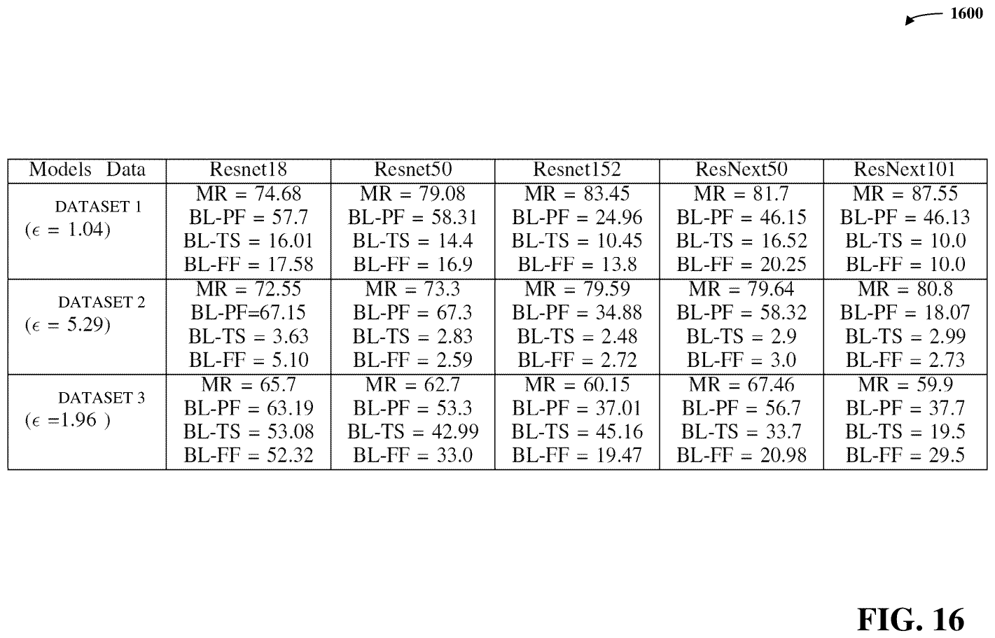

Now, consider FIG. 16. Not only was federated learning performed in the four above-described experimental fashions, but such federated learning was performed on different training datasets having respective privacy budgets, and such federated learning was also performed across different depths or sizes of source neural networks. FIG. 16 illustrates a table 1600 that tabulates various specific test accuracy percentages that were achieved during such experiments. The left-most column of the table 1600 can be considered as indicating which of three distributed training datasets were utilized in a particular experiment: a first dataset having a privacy budget of ε=1.04, a second dataset having a privacy budget of ε=5.29, and a third dataset having a privacy budget of ε=1.96. Moreover, the top-most row of the table 1600 can be considered as indicating which of five different source models was used in a particular experiment: a first source model exhibiting a Resnet18 architecture, a second source model exhibiting a Resnet50 architecture, a third source model exhibiting a Resnet152 architecture, a fourth source model exhibiting a ResNext50 architecture, and a fifth source model exhibiting a ResNext101 architecture. For any given dataset and source model architecture, the table 1600 illustrates the test accuracy percentages that were obtained by: reprogrammable federated learning as described herein (denoted “MR” in the table 1600); training-from-scratch federated learning (denoted as “BL-TS”); full fine-tuning federated learning (denoted as “BL-FF”); and partial fine-tuning federated learning (denoted as “BL-PF”). As shown, reprogrammable federated learning achieved significantly higher test accuracy than training-from-scratch, than full fine-tuning, and than partial fine-tuning, across all source model architectures and across all datasets.

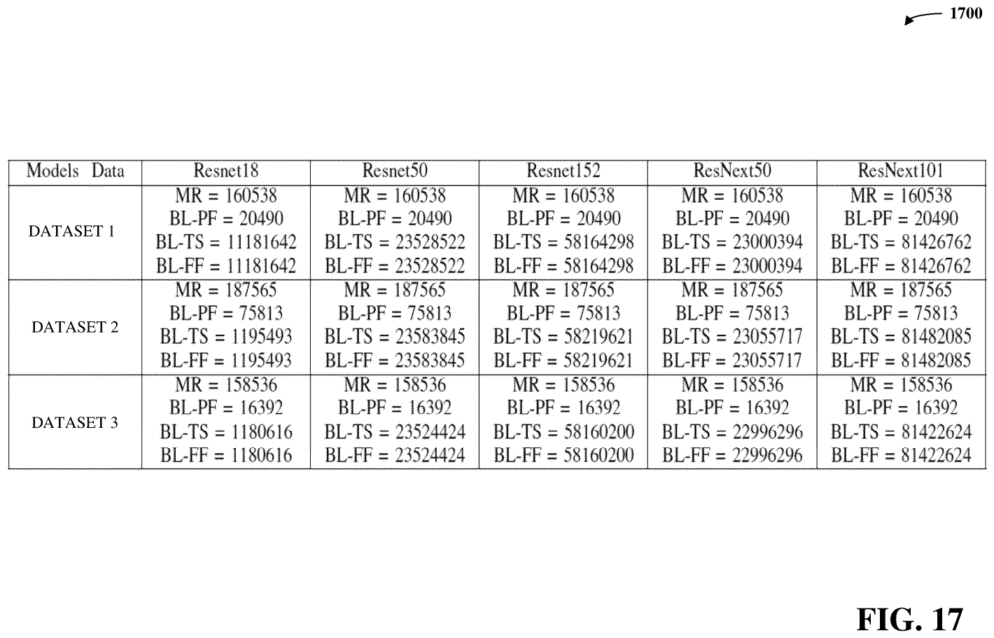

Now, consider FIG. 17. FIG. 17 illustrates a table 1700 that is structured in the same fashion as the table 1600. However, rather than showing test accuracy of each of the four tested types of federated learning across dataset and across source model architecture, the table 1700 instead shows the total number of trainable (e.g., not frozen) internal parameters of each of the four tested types of federated learning across dataset and across source model architecture. As can be seen, reprogrammable federated learning involved one or more orders of magnitude fewer trainable (e.g., non-frozen) internal parameters than training-from-scratch and full fine-tuning, across all datasets and across all source model architectures. This significantly reduced number of trainable internal parameters corresponds to a commensurately reduced communication overhead between federated learning clients and the federated learning server. Although reprogrammable federated learning did involve more trainable internal parameters than partial fine-tuning across all datasets and source model architectures, it involved only slightly more trainable internal parameters (e.g., less than an order of magnitude more). Such slight increase in trainable internal parameters can be considered as worth it in view of the significant test accuracy improvement that reprogrammable federated learning exhibits over partial fine-tuning.

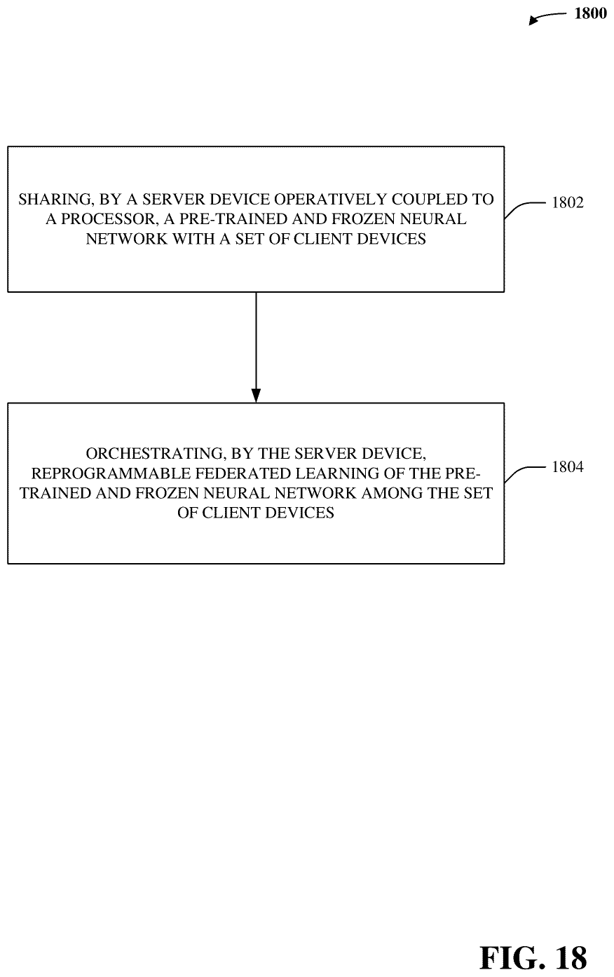

FIG. 18 illustrates a flow diagram of an example, non-limiting computer-implemented method 1800 that can facilitate reprogrammable federated learning in accordance with one or more embodiments described herein. In various aspects, the RFL server 102 can facilitate the computer-implemented method 1800.

In various embodiments, act 1802 can include sharing, by a server device (e.g., via 112 of 102) operatively coupled to a processor (e.g., 108), a pre-trained and frozen neural network (e.g., 302) with a set of client devices (e.g., 104).

In various aspects, act 1804 can include orchestrating, by the server device (e.g., via 114 of 102), reprogrammable federated learning of the pre-trained and frozen neural network among the set of client devices.

Although not explicitly shown in FIG. 18, the pre-trained and frozen neural network can be positioned between at least one trainable input layer (e.g., 402) and at least one trainable output layer (e.g., 404), and the reprogrammable federated learning can involve the at least one trainable input layer and the at least one trainable output layer, but not the pre-trained and frozen neural network, being locally adjusted by the set of client devices.

Although not explicitly shown in FIG. 18, an iteration of the reprogrammable federated learning can comprise: sharing, by the server device (e.g., via 114 of 102), a global internal parameter value array (e.g., 602) of the at least one trainable input layer and of the at least one trainable output layer with the set of client devices; and instructing, by the server device (e.g., via 114 of 102), the set of client devices to locally update the global internal parameter value array of the at least one trainable input layer and of the at least one trainable output layer using local training datasets (e.g., 106), thereby causing the set of client devices to respectively generate a set of locally-updated internal parameter value arrays (e.g., 702) of the at least one trainable input layer and of the at least one trainable output layer. In various cases, the set of client devices can perform such local updates via differentially private stochastic gradient descent.

Although not explicitly shown in FIG. 18, the iteration of the reprogrammable federated learning can comprise: accessing, by the server device (e.g., via 114 of 102), the set of locally-updated internal parameter value arrays from the set of client devices; and aggregating, by the server device (e.g., via 114 of 102), the set of locally-updated internal parameter value arrays into a new global internal parameter value array (e.g., 1002). In various cases, the server device can aggregate the set of locally-updated internal parameter value arrays via federated averaging.

Although not explicitly shown in FIG. 18, a next iteration of the reprogrammable federated learning can comprise: sharing, by the server device (e.g., via 114 of 102), the new global internal parameter value array with the set of client devices; and instructing, by the server device, the set of client devices to locally update the new global internal parameter value array using the local training datasets.

Although not explicitly shown in FIG. 18, the iteration of the reprogrammable federated learning can comprise: determining, by the server device (e.g., via 114 of 102) and via a moment accounts technique, how much of a privacy budget (e.g., ε) associated with the pre-trained and frozen neural network has been consumed by the iteration.

Although the herein disclosure mainly describes various embodiments as performing reprogrammable federated learning to deep learning neural networks, this is a mere non-limiting example. In various cases, various embodiments described herein can be implemented to perform reprogrammable federated learning with respect to any suitable machine learning models (e.g., to neural networks, to support vector machines, to naïve Bayes models, to linear or logistic regression models, to decision trees, to random forest models).

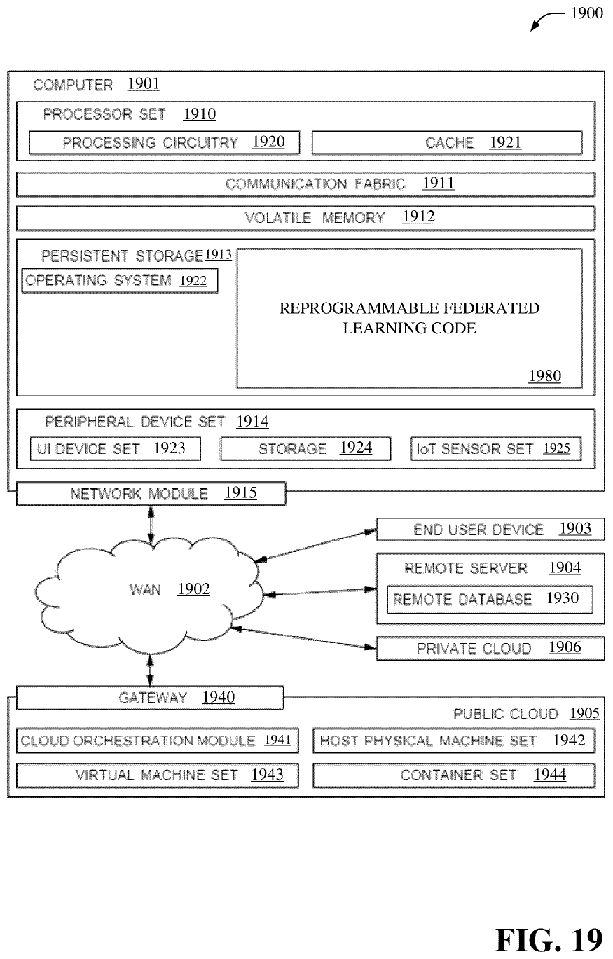

FIG. 19 and the following discussion are intended to provide a brief, general description of a suitable computing environment 1900 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1900 contains an example of an environment for the execution of at least some of the computer code involved in performing the inventive methods, such as reprogrammable federated learning code 1980. In addition to block 1980, computing environment 1900 includes, for example, computer 1901, wide area network (WAN) 1902, end user device (EUD) 1903, remote server 1904, public cloud 1905, and private cloud 1906. In this embodiment, computer 1901 includes processor set 1910 (including processing circuitry 1920 and cache 1921), communication fabric 1911, volatile memory 1912, persistent storage 1913 (including operating system 1922 and block 1980, as identified above), peripheral device set 1914 (including user interface (UI), device set 1923, storage 1924, and Internet of Things (IoT) sensor set 1925), and network module 1915. Remote server 1904 includes remote database 1930. Public cloud 1905 includes gateway 1940, cloud orchestration module 1941, host physical machine set 1942, virtual machine set 1943, and container set 1944.

COMPUTER 1901 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1930. As is well understood in the art of computer technology, and depending upon the technology, performance of a computer-implemented method can be distributed among multiple computers or between multiple locations. On the other hand, in this presentation of computing environment 1900, detailed discussion is focused on a single computer, specifically computer 1901, to keep the presentation as simple as possible. Computer 1901 can be located in a cloud, even though it is not shown in a cloud in FIG. 19. On the other hand, computer 1901 is not required to be in a cloud except to any extent as can be affirmatively indicated.

PROCESSOR SET 1910 includes one, or more, computer processors of any type now known or to be developed in the future. Processing circuitry 1920 can be distributed over multiple packages, for example, multiple, coordinated integrated circuit chips. Processing circuitry 1920 can implement multiple processor threads or multiple processor cores. Cache 1921 is memory that is located in the processor chip package(s) and is typically used for data or code that should be available for rapid access by the threads or cores running on processor set 1910. Cache memories are typically organized into multiple levels depending upon relative proximity to the processing circuitry. Alternatively, some, or all, of the cache for the processor set can be located “off chip.” In some computing environments, processor set 1910 can be designed for working with qubits and performing quantum computing.

Computer readable program instructions are typically loaded onto computer 1901 to cause a series of operational steps to be performed by processor set 1910 of computer 1901 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1921 and the other storage media discussed below. The program instructions, and associated data, are accessed by processor set 1910 to control and direct performance of the inventive methods. In computing environment 1900, at least some of the instructions for performing the inventive methods can be stored in block 1980 in persistent storage 1913.

COMMUNICATION FABRIC 1911 is the signal conduction path that allows the various components of computer 1901 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1912 is any type of volatile memory now known or to be developed in the future. Examples include dynamic type random access memory (RAM) or static type RAM. Typically, the volatile memory is characterized by random access, but this is not required unless affirmatively indicated. In computer 1901, the volatile memory 1912 is located in a single package and is internal to computer 1901, but, alternatively or additionally, the volatile memory can be distributed over multiple packages or located externally with respect to computer 1901.

PERSISTENT STORAGE 1913 is any form of non-volatile storage for computers that is now known or to be developed in the future. The non-volatility of this storage means that the stored data is maintained regardless of whether power is being supplied to computer 1901 or directly to persistent storage 1913. Persistent storage 1913 can be a read only memory (ROM), but typically at least a portion of the persistent storage allows writing of data, deletion of data and re-writing of data. Some familiar forms of persistent storage include magnetic disks and solid-state storage devices. Operating system 1922 can take several forms, such as various known proprietary operating systems or open-source Portable Operating System Interface type operating systems that employ a kernel. The code included in block 1980 typically includes at least some of the computer code involved in performing the inventive methods.

PERIPHERAL DEVICE SET 1914 includes the set of peripheral devices of computer 1901. Data communication connections between the peripheral devices and the other components of computer 1901 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1923 can include components such as a display screen, speaker, microphone, wearable devices (such as goggles and smart watches), keyboard, mouse, printer, touchpad, game controllers, and haptic devices. Storage 1924 is external storage, such as an external hard drive, or insertable storage, such as an SD card. Storage 1924 can be persistent or volatile. In some embodiments, storage 1924 can take the form of a quantum computing storage device for storing data in the form of qubits. In embodiments where computer 1901 is required to have a large amount of storage (for example, where computer 1901 locally stores and manages a large database) then this storage can be provided by peripheral storage devices designed for storing large amounts of data, such as a storage area network (SAN) that is shared by multiple, geographically distributed computers. IoT sensor set 1925 is made up of sensors that can be used in Internet of Things applications. For example, one sensor can be a thermometer and another sensor can be a motion detector.

NETWORK MODULE 1915 is the collection of computer software, hardware, and firmware that allows computer 1901 to communicate with other computers through WAN 1902. Network module 1915 can include hardware, such as modems or Wi-Fi signal transceivers, software for packetizing or de-packetizing data for communication network transmission, or web browser software for communicating data over the internet. In some embodiments, network control functions and network forwarding functions of network module 1915 are performed on the same physical hardware device. In other embodiments (for example, embodiments that utilize software-defined networking (SDN)), the control functions and the forwarding functions of network module 1915 are performed on physically separate devices, such that the control functions manage several different network hardware devices. Computer readable program instructions for performing the inventive methods can typically be downloaded to computer 1901 from an external computer or external storage device through a network adapter card or network interface included in network module 1915.

WAN 1902 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1903 is any computer system that is used and controlled by an end user (for example, a customer of an enterprise that operates computer 1901) and can take any of the forms discussed above in connection with computer 1901. EUD 1903 typically receives helpful and useful data from the operations of computer 1901. For example, in a hypothetical case where computer 1901 is designed to provide a recommendation to an end user, this recommendation would typically be communicated from network module 1915 of computer 1901 through WAN 1902 to EUD 1903. In this way, EUD 1903 can display, or otherwise present, the recommendation to an end user. In some embodiments, EUD 1903 can be a client device, such as thin client, heavy client, mainframe computer or desktop computer.

REMOTE SERVER 1904 is any computer system that serves at least some data or functionality to computer 1901. Remote server 1904 can be controlled and used by the same entity that operates computer 1901. Remote server 1904 represents the machine(s) that collect and store helpful and useful data for use by other computers, such as computer 1901. For example, in a hypothetical case where computer 1901 is designed and programmed to provide a recommendation based on historical data, then this historical data can be provided to computer 1901 from remote database 1930 of remote server 1904.

PUBLIC CLOUD 1905 is any computer system available for use by multiple entities that provides on-demand availability of computer system resources or other computer capabilities, especially data storage (cloud storage) and computing power, without direct active management by the scale. The direct and active management of the computing resources of public cloud 1905 is performed by the computer hardware or software of cloud orchestration module 1941. The computing resources provided by public cloud 1905 are typically implemented by virtual computing environments that run on various computers making up the computers of host physical machine set 1942, which is the universe of physical computers in or available to public cloud 1905. The virtual computing environments (VCEs) typically take the form of virtual machines from virtual machine set 1943 or containers from container set 1944. It is understood that these VCEs can be stored as images and can be transferred among and between the various physical machine hosts, either as images or after instantiation of the VCE. Cloud orchestration module 1941 manages the transfer and storage of images, deploys new instantiations of VCEs and manages active instantiations of VCE deployments. Gateway 1940 is the collection of computer software, hardware and firmware allowing public cloud 1905 to communicate through WAN 1902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1906 is similar to public cloud 1905, except that the computing resources are only available for use by a single enterprise. While private cloud 1906 is depicted as being in communication with WAN 1902, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1905 and private cloud 1906 are both part of a larger hybrid cloud.

The herein disclosure describes non-limiting examples of various embodiments of the subject innovation. For ease of description or explanation, various portions of the herein disclosure utilize the term “each” when discussing various embodiments of the subject innovation. Such usages of the term “each” are non-limiting examples. In other words, when the herein disclosure provides a description that is applied to “each” of some particular object or component, it should be understood that this is a non-limiting example of various embodiments of the subject innovation, and it should be further understood that, in various other embodiments of the subject innovation, it can be the case that such description applies to fewer than “each” of that particular object or component.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A server device, comprising:
a processor that executes computer-executable components stored in a non-transitory computer-readable memory, wherein the computer-executable components comprise:
a model component that shares a pre-trained and frozen neural network with a set of client devices; and
a training component that orchestrates reprogrammable federated learning of the pre-trained and frozen neural network among the set of client devices.

2. The server device of claim 1, wherein the pre-trained and frozen neural network is positioned between at least one trainable input layer and at least one trainable output layer, and wherein the reprogrammable federated learning involves the at least one trainable input layer and the at least one trainable output layer, but not the pre-trained and frozen neural network, being locally adjusted by the set of client devices.

3. The server device of claim 2, wherein, during an iteration of the reprogrammable federated learning, the training component:
shares a global internal parameter value array of the at least one trainable input layer and of the at least one trainable output layer with the set of client devices; and
instructs the set of client devices to locally update the global internal parameter value array of the at least one trainable input layer and of the at least one trainable output layer using local training datasets, thereby causing the set of client devices to respectively generate a set of locally-updated internal parameter value arrays of the at least one trainable input layer and of the at least one trainable output layer.

4. The server device of claim 3, wherein the set of client devices perform such local updates via differentially private stochastic gradient descent.

5. The server device of claim 3, wherein, during the iteration of the reprogrammable federated learning, the training component:
accesses the set of locally-updated internal parameter value arrays from the set of client devices; and
aggregates the set of locally-updated internal parameter value arrays into a new global internal parameter value array.

6. The server device of claim 5, wherein, during a next iteration of the reprogrammable federated learning, the training component:
shares the new global internal parameter value array with the set of client devices; and
instructs the set of client devices to locally update the new global internal parameter value array using the local training datasets.

7. The server device of claim 5, wherein the training component aggregates the set of locally-updated internal parameter value arrays via federated averaging.

8. The server device of claim 5, wherein, during the iteration of the reprogrammable federated learning, the training component determines, via a moment accounts technique, how much of a privacy budget associated with the pre-trained and frozen neural network has been consumed by the iteration.

9. A computer-implemented method, comprising:
sharing, by a server device operatively coupled to a processor, a pre-trained and frozen neural network with a set of client devices; and
orchestrating, by the server device, reprogrammable federated learning of the pre-trained and frozen neural network among the set of client devices.

10. The computer-implemented method of claim 9, wherein the pre-trained and frozen neural network is positioned between at least one trainable input layer and at least one trainable output layer, and wherein the reprogrammable federated learning involves the at least one trainable input layer and the at least one trainable output layer, but not the pre-trained and frozen neural network, being locally adjusted by the set of client devices.

11. The computer-implemented method of claim 10, wherein an iteration of the reprogrammable federated learning comprises:
sharing, by the server device, a global internal parameter value array of the at least one trainable input layer and of the at least one trainable output layer with the set of client devices; and
instructing, by the server device, the set of client devices to locally update the global internal parameter value array of the at least one trainable input layer and of the at least one trainable output layer using local training datasets, thereby causing the set of client devices to respectively generate a set of locally-updated internal parameter value arrays of the at least one trainable input layer and of the at least one trainable output layer.

12. The computer-implemented method of claim 11, wherein the set of client devices perform such local updates via differentially private stochastic gradient descent.

13. The computer-implemented method of claim 11, wherein the iteration of the reprogrammable federated learning comprises:
accessing, by the server device, the set of locally-updated internal parameter value arrays from the set of client devices; and
aggregating, by the server device, the set of locally-updated internal parameter value arrays into a new global internal parameter value array.

14. The computer-implemented method of claim 13, wherein a next iteration of the reprogrammable federated learning comprises:
sharing, by the server device, the new global internal parameter value array with the set of client devices; and
instructing, by the server device, the set of client devices to locally update the new global internal parameter value array using the local training datasets.

15. The computer-implemented method of claim 13, wherein the server device aggregates the set of locally-updated internal parameter value arrays via federated averaging.

16. The computer-implemented method of claim 13, wherein the iteration of the reprogrammable federated learning comprises:
determining, by the server device and via a moment accounts technique, how much of a privacy budget associated with the pre-trained and frozen neural network has been consumed by the iteration.

17. A computer program product for facilitating reprogrammable federated learning, the computer program product comprising a non-transitory computer-readable memory having program instructions embodied therewith, the program instructions executable by a processor to cause the processor to:
share a pre-trained and frozen neural network with a set of client devices; and
orchestrate reprogrammable federated learning of the pre-trained and frozen neural network among the set of client devices.

18. The computer program product of claim 17, wherein the pre-trained and frozen neural network is positioned between at least one trainable input layer and at least one trainable output layer, and wherein the reprogrammable federated learning involves the at least one trainable input layer and the at least one trainable output layer, but not the pre-trained and frozen neural network, being locally adjusted by the set of client devices.

19. The computer program product of claim 18, wherein, during an iteration of the reprogrammable federated learning, the processor:
shares a global internal parameter value array of the at least one trainable input layer and of the at least one trainable output layer with the set of client devices; and
instructs the set of client devices to locally update the global internal parameter value array of the at least one trainable input layer and of the at least one trainable output layer using local training datasets, thereby causing the set of client devices to respectively generate a set of locally-updated internal parameter value arrays of the at least one trainable input layer and of the at least one trainable output layer.

20. The computer program product of claim 19, wherein the set of client devices perform such local updates via differentially private stochastic gradient descent.
